(19) United States
(12) Patent Application Publication
(10) Pub. No.: US 2014/0247357 A1
(43) Pub. Date: Sep. 4, 2014

(54) ATTACHED MATTER DETECTOR, AND ATTACHED MATTER DETECTION METHOD

(71) Applicant: Hiroyoshi Sekiguchi, Yokohama-shi (JP)

(72) Inventor: Hiroyoshi Sekiguchi, Yokohama-shi (JP)

(21) Appl. No.: 14/352,197

(22) PCT Filed: Nov. 27, 2012
(86) PCT No.: PCT/JP2012/081226

§ 371 Date: Apr. 16, 2014

(30) Foreign Application Priority Data
Nov. 30, 2011 (JP) 2011-262113

(51) Int. Cl. H04N 7/18; H04N 5/225

(52) U.S. Cl. CPC H04N 7/183; H04N 5/225
USPC 348/148

(57) ABSTRACT

An attached matter detector includes: a light source that emits light to a transparent member; imaging device that receives light emitted from the light source and reflected by an attached matter on the transparent member, and consecutively images an image of the attached matter at a predetermined imaging frequency; and an attached matter detection processor that detects the attached matter based on an image imaged by the imaging device, wherein the light source emits light that flickers at a drive frequency different from the imaging frequency, and the imaging device receives the reflected light via an optical filter that selects and transmits the reflected light, and the attached matter detection processor detects a beat on an image generated by a difference between the imaging frequency and the drive frequency, and identifies an image region where the beat is detected as an attached matter image region.

### TECHNICAL FIELD

The present invention relates to an attached matter detector that images attached matter such as a raindrop, or the like, that is attached on a plate-shaped transparent member such as a front window, or the like, and performs detection of the attached matter based on the imaged image, and to an attached matter detection method.

### BACKGROUND ART

Japanese Patent number 4326999 discloses an image-processing system (attached matter detector) that detects foreign matter (attached matter) such as a liquid drop such as a raindrop, or the like, fog, and dust that are attached on a surface of various window glasses such as a glass used for a car, a vessel, an airplane, or the like, or a window glass of a general building. In this image-processing system, light is emitted from a light source arranged in an interior of one's own car, and illuminates a front window (plate-shaped transparent member) of the one's own car, and reflected light from the light illuminating the front window is received by an image sensor, and an image is imaged. And then, the imaged image is analyzed, and whether foreign matter such as a raindrop, or the like is attached on the front window is determined. Specifically, an edge detection operation using a Laplacian filter, or the like is performed on an image signal of the imaged image when lighting the light source, and an edge image in which a boundary between an image region of a raindrop and an image region that is not the raindrop is enhanced is created. Further, a generalized Hough transform is performed on the edge image, image regions that are round are detected, and the number of detected round image regions is counted, and the number of the detected round image regions is converted into an amount of rain, and the amount of rain is obtained.

To an image sensor, other than reflected light from a raindrop, various ambient light such as light from a headlight of an oncoming car is inputted. In a general attached matter detector such as the image-processing system disclosed in Japanese Patent number 4326999, in a case where such ambient light is inputted to the image sensor, it is not possible to sufficiently identify the reflected light from the raindrop from the ambient light, and there is a problem of a high frequency of false detection where the ambient light is identified as the reflected light from the raindrop.

### SUMMARY OF THE INVENTION

An object of the present invention is to provide an attached matter detector in which accuracy in identification that identifies light reflected from attached matter such as a raindrop, or the like attached on a transparent member from ambient light is improved, and which has a low frequency of false detection where the ambient light is identified as the light reflected from the attached matter, and an attached matter detection method.

In order to achieve the above object, an embodiment of the present invention provides attached matter detector comprising: a light source that emits light to a transparent member; an imaging device that receives light that is emitted from the light source and reflected by attached matter attached on the transparent member by an image sensor, a light-receiving element of which is structured by a two-dimensionally-arranged imaging pixel array, and consecutively images an image of the attached matter attached on the transparent member at a predetermined imaging frequency; and an attached matter detection processor that detects the attached matter based on an image imaged by the imaging device, wherein the light source emits light that flickers at a drive frequency that is different from the imaging frequency, and the imaging device receives the reflected light by the image sensor via an optical filter that selects and transmits the reflected light, and the attached matter detection processor detects a beat on an image generated by a difference between the imaging frequency and the drive frequency, and identifies an image region where the beat is detected as an attached matter image region where the attached matter is shown.

In order to achieve the above object, an embodiment of the present invention provides an attached matter detection method, comprising the steps of: emitting light to a transparent member from a light source; receiving reflected light by attached matter attached on the transparent member by an image sensor, a light-receiving element of which is two-dimensionally structured by an imaging array, and consecutively images an image of the attached matter at a predetermined imaging frequency; and detecting the attached matter based on an imaged image, wherein the light source that emits light that flickers at a drive frequency that is different from the imaging frequency is used, the reflected light is received by the image sensor via an optical filter that selects and transmits the reflected light, a beat on an image generated by a difference between the imaging frequency and the drive frequency is detected, and an image region where the beat is detected is identified as an attached matter image region where the attached matter is shown.

### BRIEF DESCRIPTION OF DRAWINGS

FIG. 1 is a schematic diagram illustrating a schematic structure of an in-car device control system according to an embodiment of the present invention.

FIG. 2 is a schematic diagram illustrating a schematic structure of an imaging unit in the in-vehicle device control system.

FIG. 3 is an explanatory diagram illustrating a schematic structure of an imaging device included in the imaging unit.

FIG. 4 is an explanatory diagram illustrating infrared light image data that is imaged image data for a raindrop detection in a case where an imaging lens is in focus on a raindrop on an outer surface of a front window of a driver's car.

FIG. 5 is an explanatory diagram illustrating infrared light image data that is imaged image data for a raindrop detection in a case where an imaging lens is in focus on infinity.

FIG. 6 is a graph illustrating a filter characteristic of a cut filter that is applicable to imaged image data for a raindrop detection.

FIG. 7 is a graph illustrating a filter characteristic of a band-pass filter that is applicable to imaged image data for a raindrop detection.

FIG. 8 is a front view of a front filter included in an optical filter of the imaging device.

FIG. 9 is an explanatory diagram illustrating an image example of the imaged image data of the imaging device.

FIG. 10 is an explanatory diagram illustrating details of the imaging device.

FIG. 11 is an enlarged schematic diagram of an optical filter and an image sensor of the imaging device when viewed from a direction perpendicular to a light transmission direction.

FIG. 12 is an explanatory diagram illustrating region division patterns of a polarization filter layer and a spectral filter layer of the optical filter.

FIG. 13 is a cross-sectional diagram schematically illustrating a layer structure of the optical filter.

FIG. 14 is an explanatory diagram illustrating contents of information (information of each imaging pixel) corresponding to an amount of light that is transmitted through a filter part for a car detection of the optical filter, and received by each photodiode on an image sensor.

FIG. 15A is a cross-sectional diagram along a dashed-line A-A in FIG. 14 schematically illustrating the filter part for the car detection of the optical filter and the image sensor. FIG. 15B is a cross-sectional diagram along a dashed-line B-B in FIG. 14 schematically illustrating the filter part for the car detection of the optical filter and the image sensor.

FIG. 16 is an explanatory diagram illustrating contents of information (information of each imaging pixel) corresponding to an amount of light that is transmitted through a filter part for a raindrop detection of the optical filter, and received by each photodiode on an image sensor.

FIG. 17A is a cross-sectional diagram along a dashed-line A-A in FIG. 16 schematically illustrating the filter part for the raindrop detection of the optical filter and the image sensor. FIG. 17B is a cross-sectional diagram along a dashed-line B-B in FIG. 16 schematically illustrating the filter part for the raindrop detection of the optical filter and the image sensor.

FIG. 18 is an explanatory diagram of various light beams related to the raindrop detection.

FIG. 19 is an explanatory diagram illustrating an example where a longitudinal direction of a metal wire of a wire grid structure is different at each position of a polarization filter layer in the filter part for the raindrop detection of the optical filter.

FIG. 20 is a flow diagram illustrating a flow of a car detection operation in an embodiment.

FIG. 21 is an explanatory diagram illustrating a polarization state of reflected light at a Brewster's angle.

FIG. 22A is an explanatory diagram illustrating an imaged image when a raindrop is attached on an outer surface of a front window. FIG. 22B is an explanatory diagram illustrating an imaged image when a raindrop is not attached on an outer surface of a front window.

FIG. 23 is an explanatory diagram illustrating a relationship between a drive frequency (light source cycle) and an imaging frequency (imaging frame cycle) in a raindrop detection operation (rolling shutter method) of an embodiment.

FIG. 24A is an explanatory diagram illustrating a state where a raindrop is shown in an image region for the raindrop detection. FIG. 24B is an enlarged diagram in the image region where the raindrop is shown.

FIG. 25 is an explanatory diagram illustrating a relationship between a drive frequency (light source cycle) and an imaging frequency (imaging frame cycle) in the global shutter method.

FIG. 26A is an enlarged diagram that enlarges a raindrop image region shown in an image region for the raindrop detection in the global shutter method.

FIG. 26B is an enlarged diagram that enlarges an image region for the raindrop detection in a next imaged image corresponding to the raindrop image region illustrated in FIG. 26A.

FIG. 27A is a graph illustrating a change of an average value of a pixel value in an image region showing a raindrop in an imaged image shot by a consecutive shooting, in a case where a light source drive frequency is 50 Hz.

FIG. 27B is a graph illustrating a change of an average value of a pixel value in an image region showing a raindrop in an imaged image shot by a consecutive shooting, in a case where a light source drive frequency is 60 Hz. FIG. 27C is a graph illustrating a change of an average value of a pixel value in an image region showing a raindrop in an imaged image shot by a consecutive shooting, in a case where a light source drive frequency is 0 Hz (that is, in a case of emitting light with no flicker).

FIG. 28 is a flow diagram illustrating a flow of a raindrop detection operation in an embodiment.

FIG. 29A is an enlarged diagram that enlarges a raindrop image region shown in an image region for a raindrop detection in the rolling shutter method. FIG. 29B is an enlarged diagram that enlarges a raindrop image region in a next imaged image corresponding to the raindrop image region illustrated in FIG. 29A.

### DESCRIPTION OF EMBODIMENTS

Hereinafter, an imaging device used in an in-car device control system according to an embodiment of the present invention will be explained.

Note that the imaging device according to an embodiment of the present invention is applicable not only to the in-car device control system but also to other systems, for example, a system including a matter detector that performs a matter detection based on an imaged image.

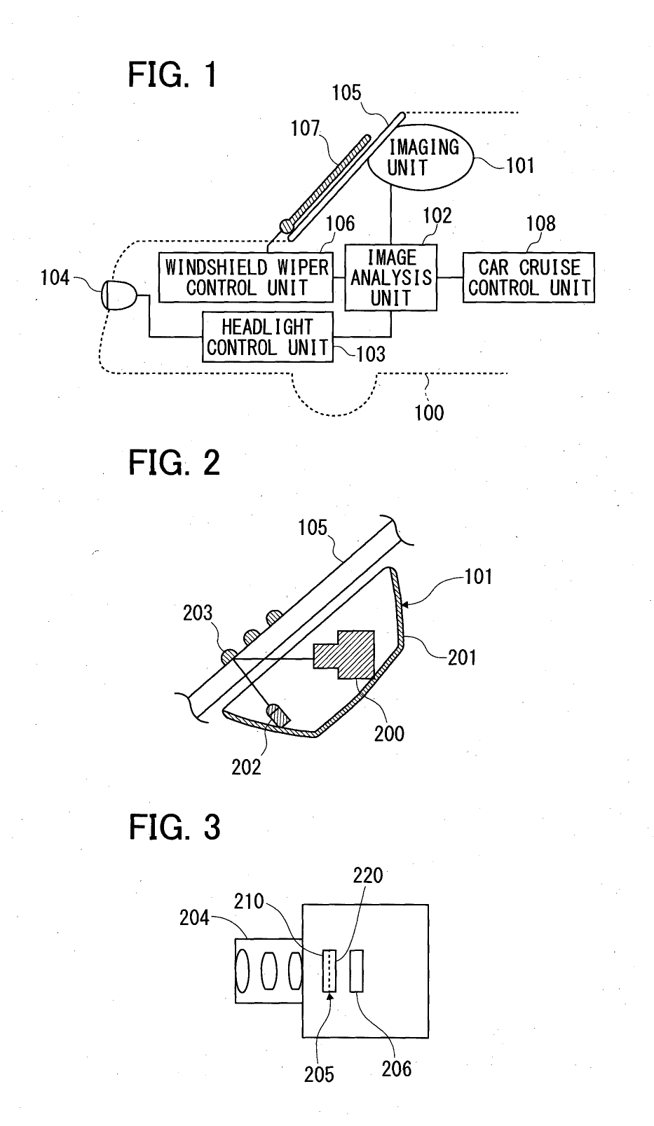

FIG. 1 is a schematic diagram illustrating a schematic structure of an in-car device control system according to an embodiment of the present invention.

The in-car device control system images a front region in a travelling direction (imaged region) of one's own car by an imaging device equipped in a driver's car (one's own car) 100, uses imaged image data of the front region in the travelling direction of the one's own car, and performs a light distribution of a headlight, a drive control of a windshield wiper, and control of other in-car devices.

An imaging device provided in the in-car device control system according to an embodiment of the present invention is included in an imaging unit 101, and images a front region in a travelling direction of a driver's car 100 as an imaged region. For example, the imaging device is arranged around a rearview mirror (not illustrated) of a front window 105 of the driver's car 100. Imaged image data by the imaging device of the imaging unit 101 is inputted to an image analysis unit 102. The image analysis unit 102 analyzes imaged image data sent from the imaging device, calculates a position, a direction, and a distance of another car that exists in front of the driver's car 100 in the imaged image data, detects attached matter such as a raindrop, foreign matter, or the like attached on the front window 105, and detects an object to be detected such as a white line on a road (road marking line) that exists in an imaged region. In detection of another car, by identifying a taillight of the other car, a car in front travelling in the same travelling direction as that of the driver's own car 100 is detected, and by identifying a headlight of the other car, an oncoming car travelling in the opposite direction to the driver's car 100 is detected.

A calculation result of the image analysis unit 102 is sent to a headlight control unit 103. The headlight control unit 103 generates a control signal that controls a headlight 104, which is an in-car device of the driver's car 100, from distance data calculated by the image analysis unit 102, for example. Specifically, for example, a switching control of high and low beams of the headlight 104, and a partial light blocking control of the headlight 104 are performed such that prevention of dazzling of a driver of the other car is performed by preventing an intense light of the headlight 104 of the driver's car 100 from being incident to eyes of the driver of a car in front, or an oncoming car, and security of a field of view of a driver of the driver's car 100 is achieved.

The calculation result of the image analysis unit 102 is also sent to a windshield wiper control unit 106. The windshield wiper control unit 106 controls a windshield wiper 107 to remove attached matter such as a raindrop, foreign matter, or the like attached on the front window 105 of the driver's car 100. The windshield wiper control unit 106 receives an attached matter detection result detected by the image analysis unit 102, and generates a control signal that controls the windshield wiper 107. When the control signal generated by the windshield wiper control unit 106 is sent to the windshield wiper 107, the windshield wiper 107 operates so as to secure the field of vision of the driver of the driver's car 100.

Additionally, the calculation result of the image analysis unit 102 is also sent to a car cruise control unit 108. The car cruise control unit 108 informs the driver of the driver's car 100 of a warning, and performs a cruise support control such as control of a steering wheel or a brake of the driver's car 100, in a case where the driver's car 100 is out of a road marking line region marked by a white line based on a white line detection result detected by the image analysis unit 102.

FIG. 2 is a schematic diagram illustrating a schematic structure of the imaging unit 101.

FIG. 3 is an explanatory diagram illustrating a schematic structure of an imaging device 200 included in the imaging unit 101.

The imaging unit 101 includes the imaging device 200, a light source 200, and a casing 201 that stores those described above. The imaging unit 101 is arranged on an inner surface side of the front window 105 of the driver's car 100. The imaging device 200, as illustrated in FIG. 3, includes an imaging lens 204, an optical filter 205, and an image sensor 206. The light source 202 is arranged such that when light is emitted from the light source 202 toward the front window 105, and reflected by an outer surface of the front window 105, the reflected light is incident to the imaging device 200.

In the present embodiment, the light source 202 is one for detection of attached matter (hereinafter, a case where the attached matter is a raindrop as an example will be explained.) attached on the outer surface of the front window 105. In a case where a raindrop 203 is not attached on the outer surface of the front window 105, light emitted from the light source 202 is reflected by an interfacial surface between the outer surface of the front window 105 and air, and the reflected light is incident to the imaging device 200. On the other hand, as illustrated in FIG. 2, in a case where the raindrop 203 is attached on the outer surface of the front window 105, a refractive index difference between the outer surface of the front window 105 and the raindrop 203 is smaller than that between the outer surface of the front window 105 and the air. Therefore, the light emitted from the light source 202 is transmitted through the interfacial surface, and is not incident to the imaging device 200. Due to this difference, detection of the raindrop 203 attached on the front window 105 is performed from imaged image data by the imaging device 200.

Additionally, in the present embodiment, as illustrated in FIG. 2, the imaging device 200 and the light source 202 of the imaging unit 101 are covered by the casing 201 with the front window 105. Thus, by being covered by the casing 201, even if the inner surface of the front window 105 is foggy, it is possible to suppress a state where the front window 105 covered by the imaging unit 101 is foggy. Therefore, it is possible to suppress a state where the image analysis unit 102 mistakenly performs analysis due to fog on the front window 105, and appropriately perform various control operations based on an analysis result of the image analysis unit 102.

However, in a case where the fog on the front window 105 is detected from the imaged image data by the imaging device 200, and, for example, an air conditioner control of the driver's car 100 is performed, a path through which the air flows may be formed in a part of the casing 201 such that a part of the front window 105 facing the imaging device 200 becomes the same state as other parts.

Here, in the present embodiment, a focus position of the imaging lens 204 is set to infinity, or between infinity and the front window 105. Therefore, not only in a case of performing detection of the raindrop attached on the front window 105, but also in a case of performing detection of a car in front, or an oncoming car, or detection of a white line, it is possible to obtain appropriate information from the imaged image data by the imaging device 200.

For example, in a case of performing the detection of the raindrop 203 attached on the front window 105, since a shape of an image of the raindrop 203 in the imaged image data is often a round shape, a shape identification operation in which whether a raindrop candidate image in the imaged image data is in a round shape or not is determined, and the raindrop candidate image is identified as the image of the raindrop is performed. In a case of performing such a shape identification operation, a case where the imaging lens 204 is in focus on infinity or between infinity and the front window 105 as described above is slightly out of focus than a case where the imaging lens 204 is in focus on the raindrop 203 on the outer surface of the front window 105, which makes a shape identification rate of the raindrop (round shape) higher, and a raindrop detection performance is high.

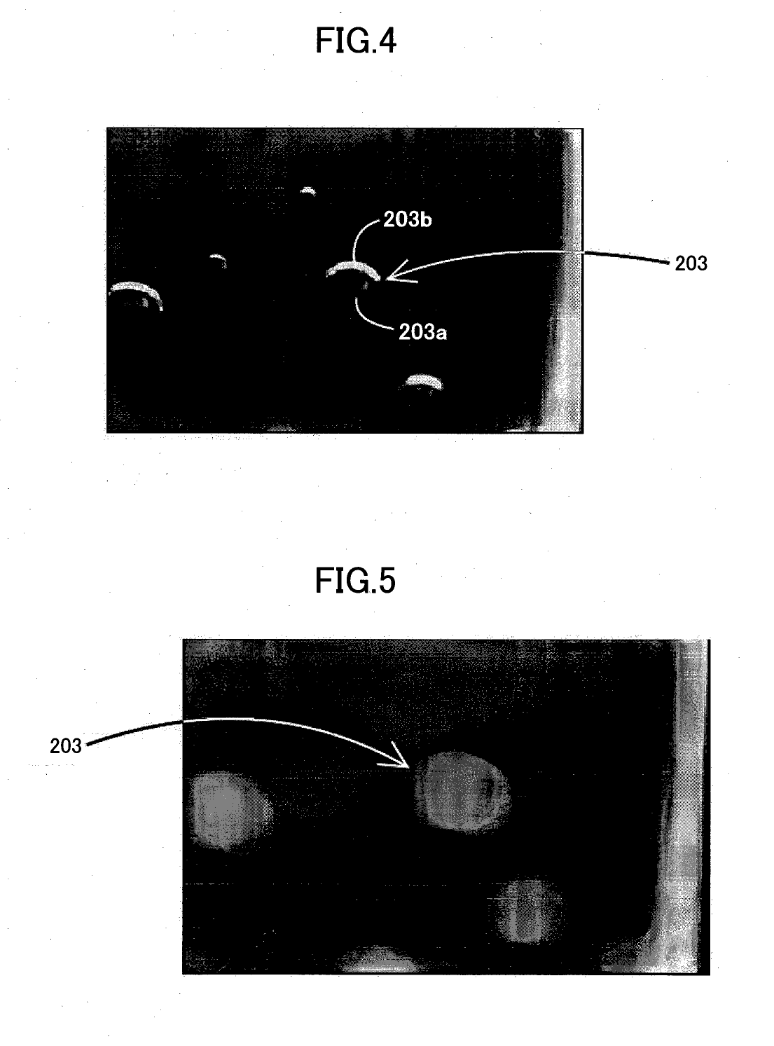

FIG. 4 is an explanatory diagram illustrating infrared light image data that is imaged image data for a raindrop detection in a case where the imaging lens 204 is in focus on the raindrop 203 on the outer surface of the front window 203.

FIG. 5 an explanatory diagram illustrating infrared light image data that is imaged image data for the raindrop detection in a case where the imaging lens 204 is in focus on infinity.

In a case where the imaging lens 204 is in focus on the raindrop 203 on the outer surface of the front window 203, as illustrated in FIG. 4, even a background image 203a reflected in the raindrop is imaged. Such a background image 203a becomes a cause of a false detection of the raindrop 203. In addition, as illustrated in FIG. 4, there is a case where brightness in only a part 203b of the raindrop becomes higher in an arch-shaped manner, or the like, and a shape of the higher brightness part, that is, the shape of the raindrop image changes depending on a direction of sunlight, a position of a street lamp, or the like. In order to perform the shape identification operation on such a raindrop image shape that thus variously changes, processing load is large, and accuracy in identification is lowered.

On the other hand, in a case where the imaging lens 204 is in focus on infinity, as illustrated in FIG. 5, a case of being slightly out of focus occurs. Therefore, reflection of the background image 203a is not reflected on the imaged image data, and the false detection of the raindrop 203 is reduced. Additionally, due to an occurrence of being slightly out of focus, the degree of change of the shape of the raindrop image depending on the direction of the sunlight, the position of the street lamp, or the like becomes small, and the shape of the raindrop image is always approximately a round shape. Therefore, the processing load of the shape identification operation of the raindrop 203 is small, and the accuracy in identification is also high.

However, in the case where the imaging lens 204 is in focus on infinity, when identifying a taillight of a car in front travelling in the distance, there is a case where the number of light-receiving elements that receives light of the taillight on the image sensor 206 is approximately one. Details will be described later; however, in this case, there is a risk that the light of the taillight is not received by a red color light-receiving element that receives a color of the taillight (red color), and therefore the taillight is not identified, and the car in front is not detected. In a case of avoiding such a risk, it is preferable to focus the imaging lens 204 on a side nearer than infinity. Thus, the taillight of the car in front travelling in the distance is out of focus; therefore, it is possible to increase the number of the light-receiving elements that receive the light of the taillight, and the accuracy in identification of the taillight increases, and accuracy in detection of the car in front improves.

A light-emitting diode (LED), a laser diode (LD), or the like can be used for the light source 202 of the imaging unit 101. Additionally, as an emission wavelength of the light source 202, for example, visible light, or infrared light can be used. However, in a case of preventing a driver of an oncoming car, a pedestrian, or the like from dazzling by the light of the light source 202, it is preferable to select a wavelength that is longer than the visible light, and in a range of a light-receiving sensitivity of the image sensor 206, for example, a wavelength of an infrared light region that is equal to or more than 800 nm and less than or equal to 1000 nm. The light source 202 of the present embodiment emits light having the wavelength of the infrared light region.

Here, in a case of imaging an infrared wavelength light emitted from the light source 202 and reflected by the front window 105 by the imaging device 200, the image sensor 206 of the imaging device 200 also receives a large amount of ambient light including infrared wavelength light such as sunlight, for example, in addition to the infrared wavelength light emitted from the light source 202. Therefore, in order to identify the infrared wavelength light emitted from the light source 202 from such a large amount of ambient light, it is necessary to sufficiently increase a light emission amount than the ambient light. However, there are many cases where it is difficult to use a light source 202 of such a large light emission amount.

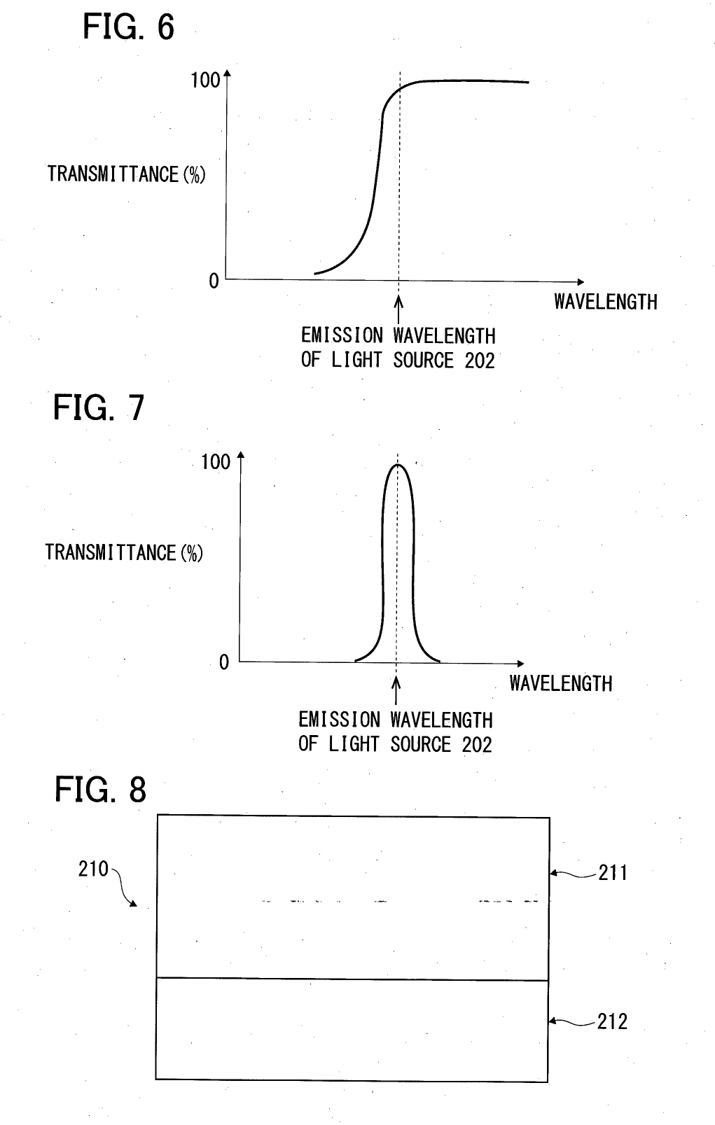

Accordingly, the present embodiment is structured such that the image sensor 206 receives the light emitted from the light source 202, for example, via a cut filter so as to cut light of shorter wavelength than an emission wavelength of the light source 202 as illustrated in FIG. 6, or via a bandpass filter where a peak of transmittance approximately corresponds to the emission wavelength of the light source 202 as illustrated in FIG. 7. Accordingly, it is possible to receive the light emitted from the light source 202 to remove light other than the emission wavelength of the light source 202, and an amount of light emitted from the light source 202 and received by the image sensor 206 relatively increases with respect to the ambient light. As a result, it is possible to identify the light emitted from the light source 202 from the ambient light, without using the light source 202 of the large light emission amount.

However, in the present embodiment, from the imaged image data, not only the detection of the raindrop 203 on the front window 105, but also the detection of the car in front, or the oncoming car, and the detection of the white line are performed. Therefore, if a wavelength range other than the infrared wavelength light emitted from the light source 202 is removed from an entire imaged image, it is not possible to receive light in a wavelength range that is necessary to perform the detection of the car in front, or the oncoming car, and the detection of the white line, which interferes with those detections. Accordingly, in the present embodiment, an image region of the imaged image data is divided into an image region for a raindrop detection to detect the raindrop 203 on the front window 105, and an image region for a car detection to perform the detection of the car in front, or the oncoming car, and the detection of the white line, and a filter that removes the wavelength range other than the infrared wavelength light emitted from the light source 202 only with respect to a part corresponding to the image region for the raindrop detection is arranged at the optical filter 205.

FIG. 8 is a front view of a front filter 210 provided at the optical filter 205.

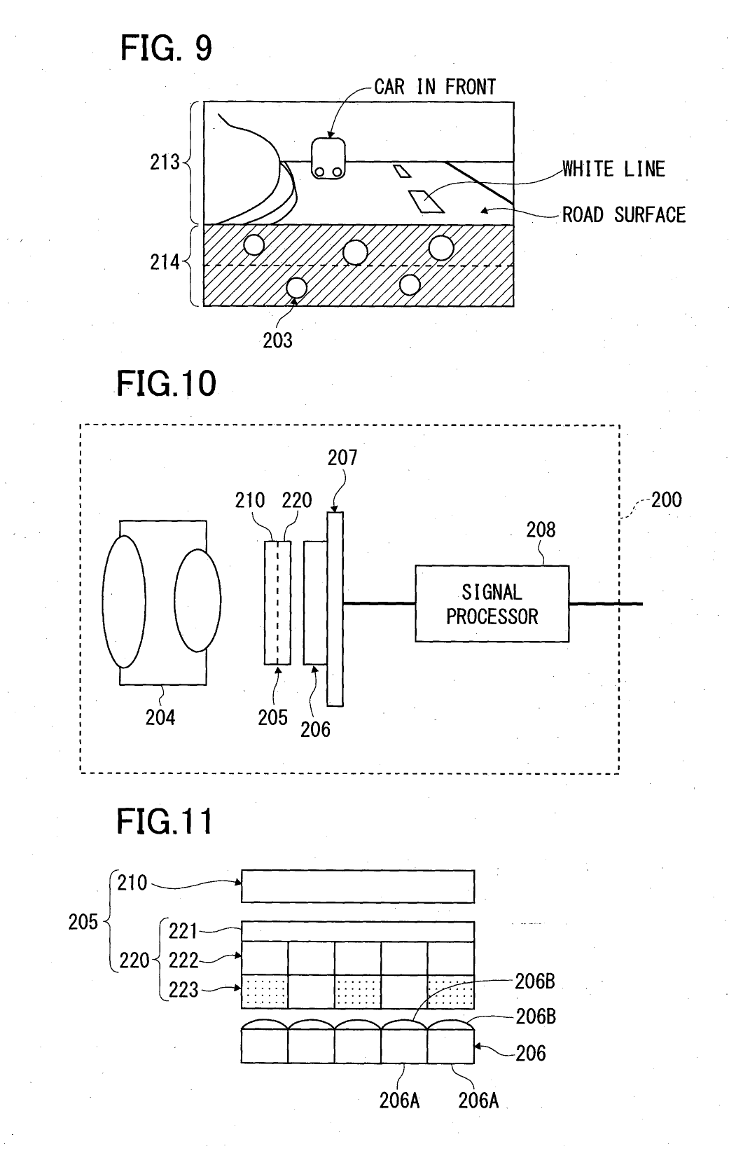

FIG. 9 is an explanatory diagram illustrating an example of an image of imaged image data.

As illustrated in FIG. 3, the optical filter 205 of the present embodiment has the front filter 210 and a rear filter 220, and has a structure such that they are layered in a light transmission direction. As illustrated in FIG. 8, the front filter 210 is divided into an infrared light cut filter region 211 arranged in a part corresponding to an upper part, ⅔ of the imaged image that is the image region for the car detection 213, and an infrared light transmission filter region 212 arranged in a part corresponding to a lower part, ⅓ of the imaged image that is the image region for the raindrop detection 214. In the infrared light transmission filter region 212, the cut filter illustrated in FIG. 6, or the bandpass filter as illustrated in FIG. 7 is used.

Images of a headlight of an oncoming car, a taillight of a car in front, and a white line often exist in the upper part of the imaged image, and in the lower part of the imaged image, an image of a nearest road surface in front of the driver's car 100 normally exists. Therefore, necessary information for identification of the headlight of the oncoming car, the taillight of the car in front, and the white line are concentrated in the upper part of the imaged image, and the lower par of the imaged image is not so important for the identification of those. Therefore, in a case where both the detection of the oncoming car, the car in front, or the white line, and the detection of the raindrop are performed from single imaged image data, as illustrated in FIG. 9, the lower part of the imaged image is taken as the image region for the raindrop detection 214, and the rest, the upper part, of the imaged image is taken as the image region for the car detection 213, and it is preferable to divide the front filter 210 into regions corresponding to the above.

When inclining an imaging direction of the imaging device 200 downward, there is a case where a car hood of the driver's car 100 is captured in the lower part of the imaged region. In this case, sunlight reflected by the car hood of the driver's car 100, the taillight of the car in front, or the like becomes ambient light, which is included in the imaged image data, and becomes a cause of a false identification of the headlight of the oncoming car, the taillight of the car in front, and the white line. Even in such a case, in the present embodiment, in the part corresponding to the lower part of the imaged image, the cut filter illustrated in FIG. 6, or the bandpass filter illustrated in FIG. 7 is arranged, and therefore the ambient light such as the sunlight reflected by the car hood, the taillight of the car in front, or the like is removed. Accordingly, the accuracy in identification of the headlight of the on coming car, the taillight of the car in front, and the white line is improved.

Note that in the present embodiment, due to a characteristic of the imaging lens 204, a view in the imaged region and an image on the image sensor 206 are vertically reversed to each other. Therefore, in a case where the lower part of the imaged image is taken as the image region for the raindrop detection 214, the cut filter illustrated in FIG. 6, or the bandpass filter illustrated in FIG. 7 constitutes an upper part of the front filter 210 of the optical filter 205.

Here, in a case of detecting a car in front, the detection of the car in front is performed by identifying a taillight of the car in front in the imaged image. However, a light amount of the taillight is smaller than that of a headlight of an oncoming car, and lots of ambient light such as a street lamp and the like exist, and therefore it is difficult to detect the taillight accurately only from mere brightness data. Accordingly, spectral information is used for the identification of the taillight, and it is necessary to identify the taillight based on a received-light amount of red light. In the present embodiment, as described later, at the rear filter 220 of the optical filter 205, a red-color filter corresponding to a color of the taillight, or a cyan filter (a filter that transmits only a wavelength range of the color of the taillight) is arranged, and the received-light amount of the red light is detected.

However, each light-receiving element constituting the image sensor 206 of the present embodiment has sensitivity with respect to light in an infrared wavelength range. Therefore, when the image sensor 206 receives the light including the infrared wavelength range, an obtained imaged image may be entirely a reddish one. As a result, there is a case where it is difficult to identify a red color image part corresponding to the taillight. Therefore, in the present embodiment, in the front filter 210 of the optical filter 205, a part corresponding to the image region for the car detection 213 is taken as the infrared light cut filter region 211. Thus, the infrared wavelength range is removed from an imaged image data part used for identification of the taillight, and the accuracy in identification of the taillight is improved.

FIG. 10 is an explanatory diagram illustrating details of the imaging device 200 in the present embodiment.

The imaging device 200 mainly includes the imaging lens 204, the optical filter 205, a sensor substrate 207, and a signal processor 208. The sensor substrate 207 includes the image sensor 206 that has a pixel array two-dimensionally arranged. The signal processor 208 generates and outputs imaged image data that is a digital electric signal converted from an analog electric signal (a received-light amount received by each light-receiving element on the image sensor 206) outputted from the sensor substrate 207. Light from an imaged area including a photographic subject (object to be detected), through the imaging lens 204, is transmitted through the optical filter 205, and converted into an electric signal in accordance with intensity of the light by the image sensor 206. When the electric signal (analog signal) outputted from the image sensor 206 is inputted to the signal processor 208, from the electric signal, the signal processor 208 outputs a digital signal that shows brightness (luminance) of each pixel on the image sensor 206 as imaged image data, with horizontal and vertical synchronization signals of the image to the following unit.

FIG. 11 is an enlarged schematic diagram of the optical filter 205 and the image sensor 206 when viewed from a direction perpendicular to a light transmission direction.

The image sensor 206 is an image sensor using a CCD (Charge-Coupled Device), a CMOS (Complementary Metal Oxide Semiconductor), or the like, and as a light-receiving element of which, a photodiode 206A is used. The photodiode 206A is two-dimensionally arranged in an array manner per pixel, and in order to increase a light collection efficiency of the photodiode 206A, a micro lens 206B is provided on an incident side of each photodiode 206A. The image sensor 206 is connected on a PWB (Printed Wiring Board) by a wire bonding method, or the like, and the sensor substrate 207 is formed.

On a side of the micro lens 206B of the image sensor 206, the optical filter 205 is closely arranged. The rear filter 220 of the optical filter 205 has a layer structure in which a polarization filter layer 222 and a spectral filter layer 223 are sequentially formed on a transparent filter substrate 221, as illustrated in FIG. 11. Each region of the polarization filter layer 222 and the spectral filter layer 223 is correspondingly divided into one photodiode 206A on the image sensor 206.

Between the optical filter 205 and the image sensor 206, an air gap can be disposed. However, the optical filter 205 is closely in contact with the image sensor 206, so that it is easy to conform a boundary of each region of the polarization filter layer 222 and the spectral filter layer 223 of the optical filter 205 to a boundary among the photodiode 206A on the image sensor 206. The optical filter 205 and the image sensor 206, for example, can be bonded with a UV adhesive agent, or a quadrilateral region outside of an effective pixel range using imaging can be bonded by a UV adhesion or a thermal compression bonding in a state of being supported by a spacer outside of the effective pixel range.

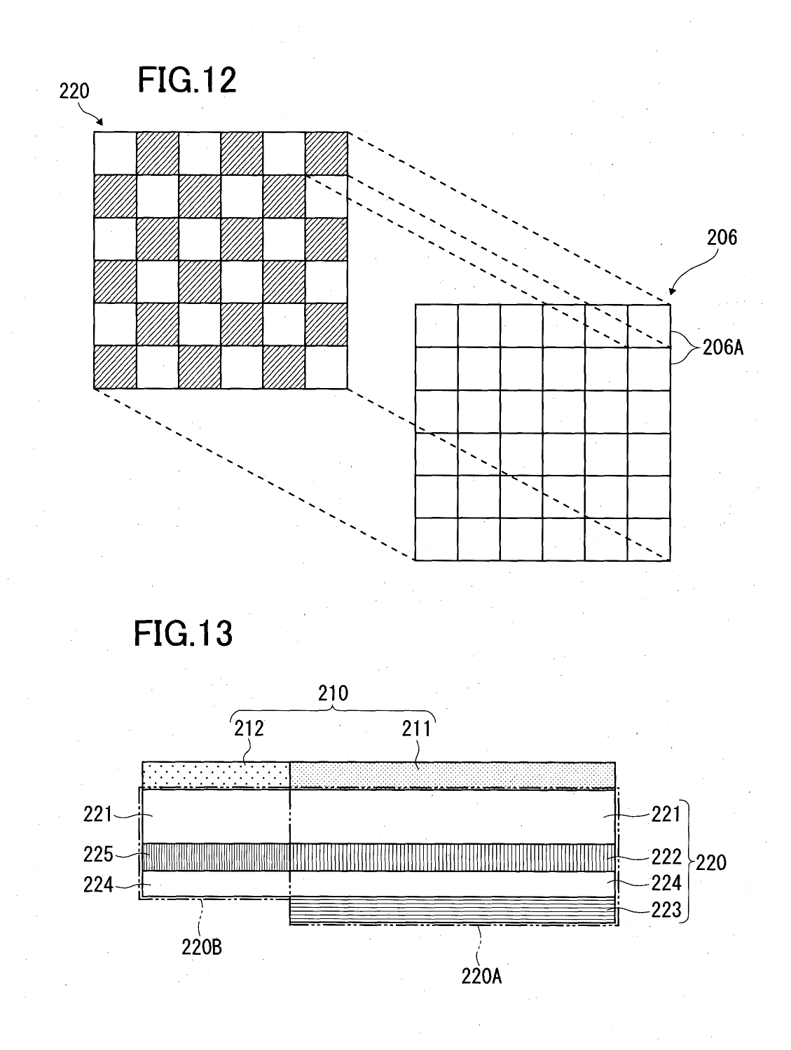

FIG. 12 is an explanatory diagram illustrating a region division pattern of the polarization filter layer 222 and the spectral filter layer 223 of the optical filter 205.

With respect to each of the polarization filter layer 222 and the spectral filter layer 223, each of two types of regions of first and second regions is correspondingly arranged on one photodiode 206A on the image sensor 206, respectively. Thus, it is possible to obtain a received-light amount received by each photodiode 206A on the image sensor 206 as polarization information, spectral information, or the like, in accordance with the types of the regions of the polarization filter layer 222 and the spectral filter layer 223 through which the received light transmits.

Note that the present embodiment is explained assuming that the image sensor 206 is an imaging element for a monochrome image; however, the image sensor 206 can be constituted by an imaging element for a color image. In a case where the image sensor 206 is constituted by the imaging element for the color image, a light transmission characteristic of each region of the polarization filter layer 222 and the spectral filter layer 223 can be adjusted in accordance with a characteristic of a color filter attached to each imaging pixel of the imaging element for the color image.

Here, an example of the optical filter 205 in the present embodiment will be explained.

FIG. 13 is a cross-sectional diagram schematically illustrating a layer structure of the optical filter 205 in the present embodiment.

In the rear filter 220 of the optical filter 205 in the present embodiment, layer structures of a filter part for the car detection 220A corresponding to the image region for the car detection 213 and a filter part for the raindrop detection 220B corresponding to the image region for the raindrop detection 214 are different. In particular, the filter part for the car detection 220A has the spectral filter layer 223, but the filter part for the raindrop detection 220B does not have the spectral filter layer 223. In addition, a structure of the polarization filter layers 222, 225 is different in the filter part for the car detection 220A and the filter part for the raindrop detection 220B.

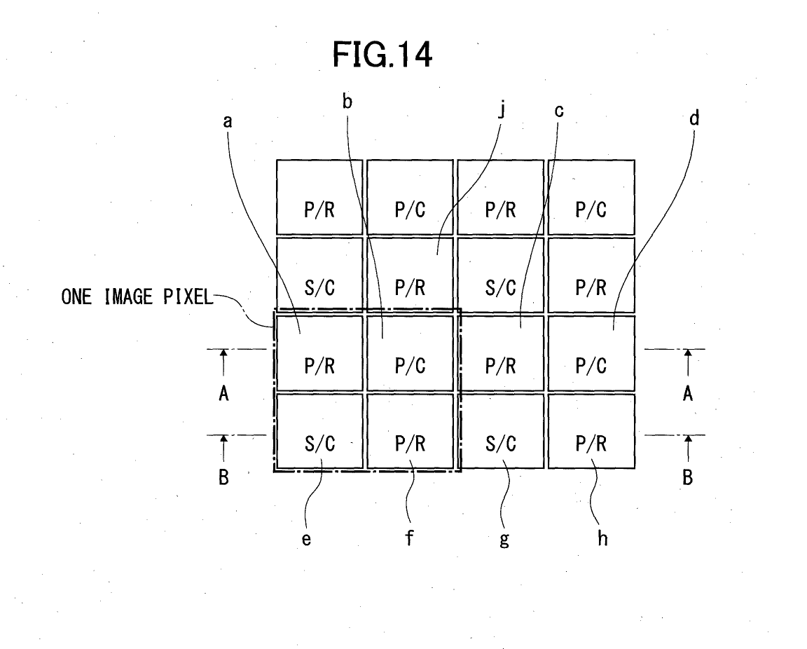

FIG. 14 is an explanatory diagram illustrating contents of information (information of each imaging pixel) corresponding to an amount of light that is transmitted through the filter part for the car detection 220A of the optical filter 205 and received by each photodiode 206A on the image sensor 206 in the present embodiment.

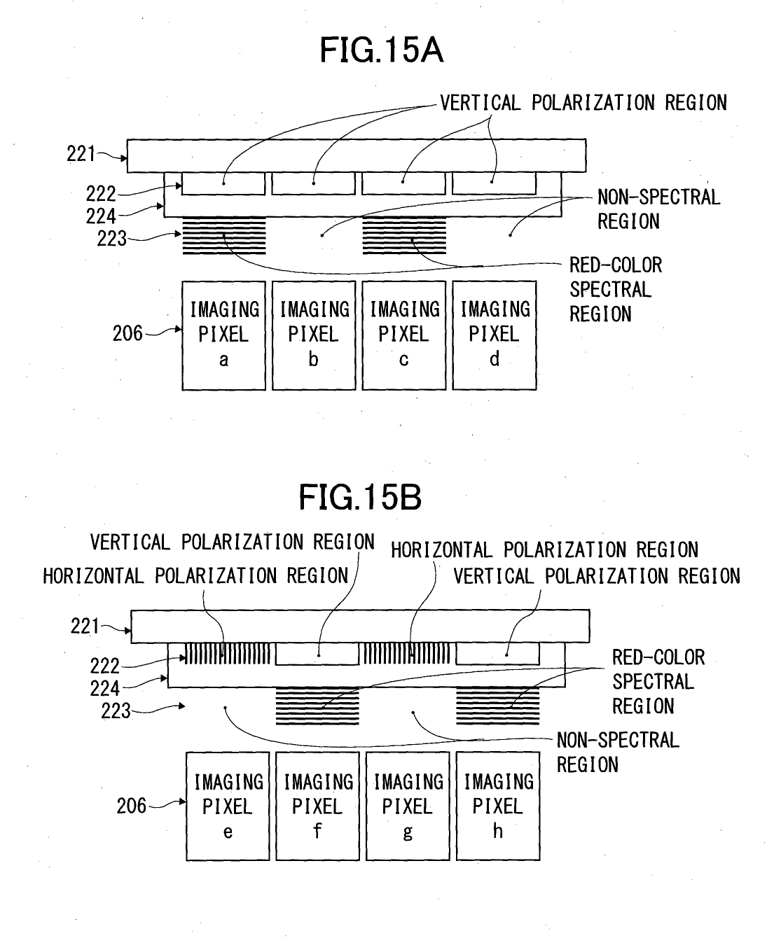

FIG. 15A is a cross-sectional diagram along a dashed-line A-A in FIG. 14 schematically illustrating the filter part for the car detection 220A of the optical filter 205 and the image sensor 206. FIG. 15B is a cross-sectional diagram along a dashed-line B-B in FIG. 14 schematically illustrating the filter part for the car detection 220A of the optical filter 205 and the image sensor 206.

The filter part for the car detection 220A of the optical filter 205 in the present embodiment has a layer structure where the polarization filter layer 222 is formed on the transparent filter substrate 221, and then the spectral filter layer 223 is formed on the polarization filter layer 222, as illustrated in FIGS. 15A and 15B. The polarization filter layer 222 has a wire grid structure, and an upper surface in a layer direction (downside surface in FIGS. 15A and 15B) of the polarization filter layer 222 is a corrugated surface. On such a corrugated surface, if the spectral filter layer 223 is formed directly, the spectral filter layer 203 is formed along the corrugated surface, and there is a case where unevenness of a layer thickness of the spectral filter layer 223 occurs, and original spectral performance is not obtained. Therefore, as for the optical filter 205 in the present embodiment, an upper surface side in the layer direction of the polarization filter layer 222 is filled with a filler 224 and flattened, and then the spectral filter layer is formed on the filler 224.

A material of the filler 224 can be a material that does not affect a function of the polarization filter layer 222, the corrugated surface of which is flattened by the filler 224. Therefore, in the present embodiment, a material without a polarization function is used. In addition, as a flattening operation using the filler 224, for example, a method of applying the filler 224 by a spin-on-glass method can be suitably adopted; however, it is not limited thereto.

In the present embodiment, the first region of the polarization filter layer 222 is a vertical polarization region that selects and transmits only a vertical polarization component that oscillates parallel to a vertical row (vertical direction) of imaging pixels of the image sensor 206, and the second region of the polarization filter layer 222 is a horizontal polarization region that selects and transmits only a horizontal polarization component that oscillates parallel to a horizontal row (horizontal direction) of imaging pixels of the image sensor 206.

Additionally, the first region of the spectral filter layer 223 is a red-color spectral region that selects and transmits only light of a red-color wavelength range (specific wavelength range) included in a used wavelength range that is transmittable through the polarization filter layer 222, and the second region of the spectral filter layer 223 is a non-spectral region that transmits light without performing a wavelength selection. In the present embodiment, as shown surrounded by a heavy dashed-line in FIG. 14, one image pixel of imaged image data is constituted by a total of four imaging pixels (four imaging pixels denoted by reference signs a, b, e, f) of two adjacent vertical and two adjacent horizontal imaging pixels.

The imaging pixel “a” illustrated in FIG. 14 receives light transmitted through the vertical polarization region (first region) of the polarization filter layer 222 and the red-color spectral region (first region) of the spectral filter layer 223 of the optical filter 205. Therefore, the imaging pixel “a” receives light P/R of the red-color wavelength range (denoted by reference sign R in FIG. 14) of the vertical polarization component (denoted by reference sign P in FIG. 14).

The imaging pixel “b” illustrated in FIG. 14 receives light transmitted through the vertical polarization region (first region) of the polarization filter layer 222 and the non-spectral region (second region) of the spectral filter layer 223 of the optical filter 205. Therefore, the imaging pixel “b” receives light P/C of non-spectral light (denoted by reference sign C) of the vertical polarization component P.

The imaging pixel “e” illustrated in FIG. 14 receives light transmitted through the horizontal polarization region (second region) of the polarization filter layer 222 and the non-spectral region (second region) of the spectral filter layer 223 of the optical filter 205. Therefore, the imaging pixel “e” receives light S/C of the non-spectral light C of the horizontal polarization component denoted by reference sign S in FIG. 14).

The imaging pixel “f” illustrated in FIG. 14 receives light transmitted through the vertical polarization region (first region) of the polarization filter layer 222 and the red-color spectral region (first region) of the spectral filter layer 223 of the optical filter 205. Therefore, the imaging pixel “f” receives light P/R of the red-color wavelength range R of the vertical polarization component P as well as the imaging pixel “a”.

By the above-described structure, according to the present embodiment, one image pixel with respect to an image of the vertical polarization component of the red light is obtained from output signals of the imaging pixel “a” and the imaging pixel “f”, one image pixel with respect to an image of the vertical polarization component of the non-spectral light is obtained from an output signal of the imaging pixel “b”, and one image pixel with respect to an image of the horizontal polarization component of the non-spectral light is obtained from an output signal of the imaging pixel “e”. Therefore, according to the present embodiment, a single imaging operation makes it possible to obtain three kinds of imaged image data, namely, the image of the vertical polarization component of the red light, the image of the vertical polarization component of the non-spectral light, and the image of the horizontal polarization component of the non-spectral light.

Note that in the above imaged image data, the number of image pixels is smaller than the number of the imaging pixels. However, in a case of obtaining a higher-resolution image, a generally-known image interpolation technique can be used. For example, in a case of obtaining the image of the vertical polarization component of the red light having higher resolution, with respect to image pixels corresponding to the imaging pixel “a” and the imaging pixel “f”, information of the vertical polarization component P of the red light received by those imaging pixels “a, and f” is directly used, and with respect to an image pixel corresponding to the imaging pixel “b”, for example, an average value of the imaging pixels “a, c, f, and j” surrounding around the imaging pixel “b” is used as information of the vertical polarization component of the red light of the image pixel.

In addition, in the case of obtaining the image of the horizontal polarization component of the non-spectral light having higher resolution, with respect to an image pixel corresponding to the imaging pixel “e”, information of the horizontal polarization component S of the non-spectral light received by the imaging pixel “e” is directly used, and with respect to image pixels corresponding to the imaging pixels “a, b, and f”, an average value of the imaging pixel “e”, the imaging pixel “g”, or the like that receives the horizontal polarization component of the non-spectral light surrounding around the imaging pixels “a, b, and f” is used, and the same value as the imaging pixel “e” can be used.

The image of the vertical polarization component of the red light thus obtained, for example, can be used for identification of a taillight. The horizontal polarization component S is cut in the image of the vertical polarization component of the red light; therefore, it is possible to obtain a red color image in which an ambient factor due to the red light in which the horizontal polarization component S is intense as red light reflected by a road surface, red light (reflected light) from a dashboard in an interior of the driver's car 100, or the like is suppressed. Accordingly, by using the image of the vertical polarization component of the red light for the identification of the taillight, the identification rate of the taillight is improved.

In addition, the image of the vertical polarization component of the non-spectral light can be used for an identification of a white line, or a headlight of an oncoming car, for example. The horizontal polarization component S is cut in the image of the vertical polarization component of the non-spectral light; therefore, it is possible to obtain a non-spectral image in which an ambient factor due to white light in which the horizontal polarization component S is intense as white light reflected by a road surface, white light (reflected light) from a dashboard in an interior of the driver's car 100, or the like is suppressed. Accordingly, by using the image of the vertical polarization component of the non-spectral light for the identification of the white line, or the headlight of the oncoming car, those identification rates are improved. In particular, it is generally known that on a road in the rain, there are many horizontal polarization components S in reflected light from a wet road surface. Accordingly, by using the image of the vertical polarization component of the non-spectral light for the identification of the white line, it is possible to appropriately identify the white line on the wet road surface, and the identification rates are improved.

Additionally, if using a comparison image in which an index value in which each pixel value is compared between the image of the vertical polarization component of the non-spectral light and the image of the horizontal polarization component of the non-spectral light is taken as a pixel value, as described later, highly-accurate identification of a metal object in the imaged region, a wet/dry condition of a road surface, a three-dimensional object in the imaged region, and the white line on the road in the rain is possible. As the comparison image used here, for example, a difference image in which a difference value of a pixel value between the image of the vertical polarization component of the non-spectral light and the image of the horizontal polarization component of the non-spectral light is taken as a pixel value, a ratio image in which a ratio of a pixel value between those images is taken as a pixel value, a difference polarization degree image in which a ratio (difference polarization degree) of the difference value of the pixel value between those images with respect to a total pixel value between those images is taken as a pixel value, or the like can be used.

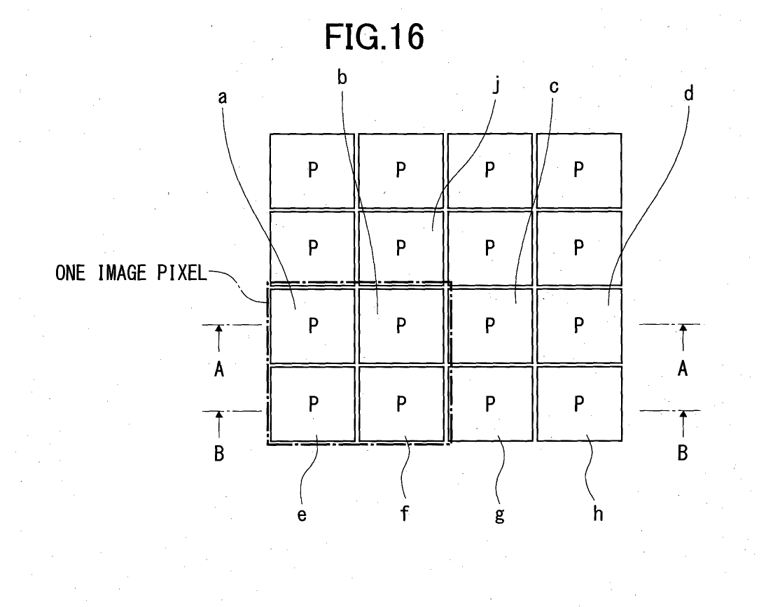

FIG. 16 is an explanatory diagram illustrating contents of information (information of each imaging pixel) corresponding to an amount of light that is transmitted through the filter part for the raindrop detection 220B of the optical filter 205 and received by each photodiode 206A on the image sensor 206 in the present embodiment.

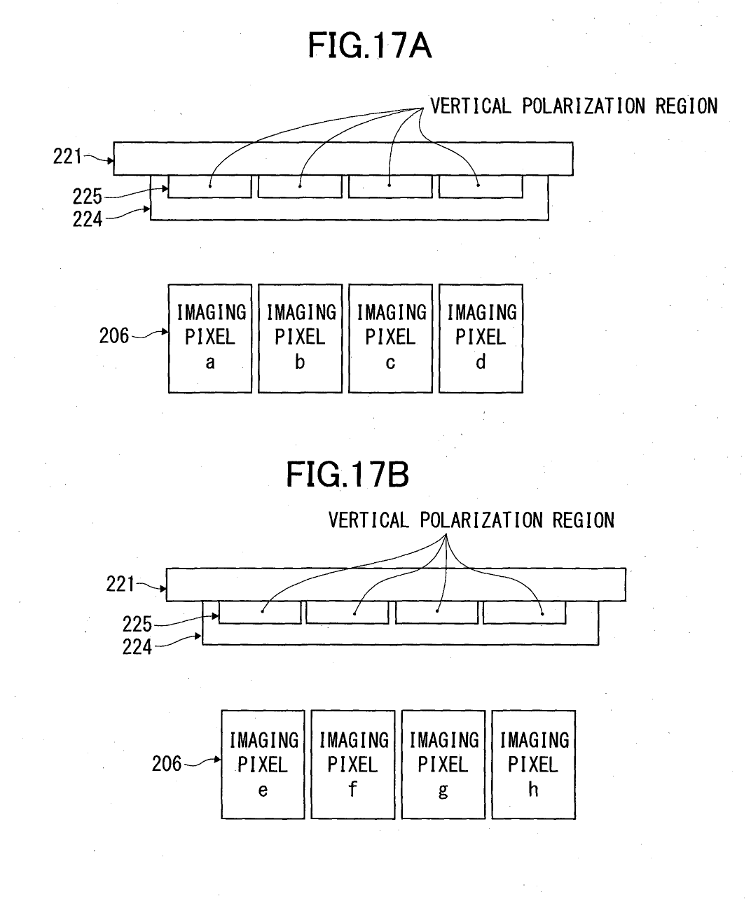

FIG. 17A is a cross-sectional diagram along a dashed-line A-A in FIG. 16 schematically illustrating the filter part for the raindrop detection 220A of the optical filter 205 and the image sensor 206.

FIG. 17B is a cross-sectional diagram along a dashed-line B-B in FIG. 16 schematically illustrating the filter part for the raindrop detection 220B of the optical filter 205 and the image sensor 206.

In the filter part for the raindrop detection 220B of the optical filter 205 in the present embodiment, a wire-grid-structured polarization filter layer 225 is formed on the filter substrate 221 shared by the filter part for the raindrop detection 220A, as illustrated in FIGS. 17A and 17B. The polarization filter layer 225 is flattened by filling the upper surface side in the layer direction with the filler 224, together with the polarization filter layer 222 of the filter part for the raindrop detection 220A. However, the filter part for the raindrop detection 220B is different from the filter part for the raindrop detection 220A, and the spectral filter layer 223 is not layered.

In the present embodiment, a view of an interior side of the driver's car 100 is often reflected on an inner surface of the front window 105. This reflection is caused by light specularly-reflected by the inner surface of the front window 105. Since this reflection is specularly-reflected light, it is ambient light, the intensity of which is relatively large. Therefore, when this reflection is shown in the image region for the raindrop detection 214 with raindrops, accuracy in raindrop detection is lowered. Additionally, when speculary-reflected light that is emitted from the light source 202 and specularly-reflected by the inner surface of the front window 105 is shown in the image region for the raindrop detection 214 with raindrops, the specularly-reflected light also becomes ambient light, and lowers the accuracy in the raindrop detection.

Since such ambient light that lowers the accuracy in the raindrop detection is specularly-reflected light that is specularly-reflected by the inner surface of the front window 105, most of its polarization component is a polarization component, a polarization direction of which is vertical to a light-source incidence plane, that is, the horizontal polarization component S that oscillates parallel to a horizontal row (horizontal direction) of the imaging pixels of the image sensor 206. Therefore, in the polarization filter layer 225 in the filter part of the raindrop detection 220B of the optical filter 205 in the present embodiment, a transmission axis is set so as to transmit a polarization component, the polarization direction of which is parallel to a virtual plane (light-source incidence plane) including an optical axis of light that is emitted from the light source 202 and travels toward the front window 105 and an optical axis of the imaging lens 204, that is, only the vertical polarization component P that oscillates parallel to the vertical row (vertical direction) of the imaging pixels of the image sensor 206.

Therefore, light transmitted through the polarization filter layer 225 of the filter part for the rain detection 220B is only the vertical polarization component P, and it is possible to cut the horizontal polarization component S that occupies a large amount of the ambient light of the reflection of the inner surface of the front window 105, the specularly-reflected light that is emitted from the light source 202 and specularly-reflected by the inner surface of the front window 105, or the like. As a result, the image region for the raindrop detection 214 is for a vertical polarization image of the vertical polarization component P that is less affected by the ambient light, and the accuracy in the raindrop detection based on the imaged image data of the image region for the raindrop detection is improved.

In the present embodiment, each of the infrared light cut filter region 211 and the infrared light transmission filter region 212 constituting the front filter 210 is formed by multilayer films having different layer structures. As a production method of such a front filter 210, there is a method such that after filming a part of the infrared light transmission filter region 212 by vacuum deposition, covering a mask with the part of the infrared light cut filter region 212, and then covering the part of the infrared light transmission filter region 212 with the mask, a part of the infrared light cut filter 211 is filmed by the vacuum deposition.

Additionally, in the present embodiment, each of the polarization filter layer 222 of the filter part for the car detection 220A and the polarization filter layer 225 of the filter part for the raindrop detection 220B has a wire grid structure that is regionally divided in a two-dimensional direction; however, the former polarization filter layer 222 is one in which two types of regions (vertical polarization region and horizontal polarization region) in which transmission axes are perpendicular to each other are regionally divided by an imaging pixel unit, and the latter polarization filter layer 225 is one in which one type of a region having a transmission axis that transmits only the vertical polarization component P is regionally divided by an imaging pixel unit. In a case of forming the polarization filters 222, 225 having such different structures on the same filter substrate 221, for example, by adjusting a groove direction of a template (equivalent to a mold) performing a patterning of a metal wire having a wire grid structure, adjustment of a longitudinal direction of the metal wire of each region is easy.

Note that in the present embodiment, the optical filter 205 is not provided with the infrared light cut filter region 211, but the imaging lens 204 can be provided with the infrared light cut filter region 211. In this case, production of the optical filter 205 is easy.

Additionally, in place of the infrared light cut filter region 211, a spectral filter layer that transmits only the vertical polarization component P can be formed in the filter part for the raindrop detection 220B of the rear filter 202. In this case, it is not necessary to form the infrared light cut filter region 211 in the front filter 210.

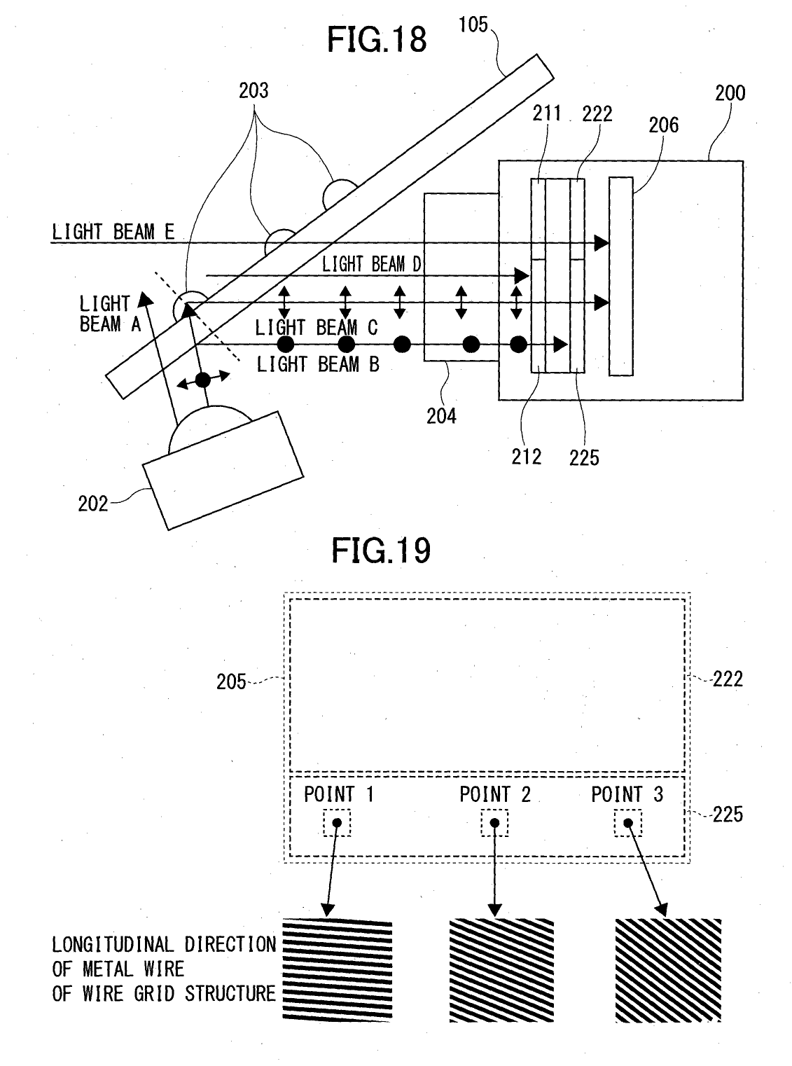

FIG. 18 is an explanatory diagram of various light beams in regard to the raindrop detection.

The light source 202 is arranged such that the specularly-reflected light by the outer surface of the front window 105 approximately corresponds to the optical axis of the imaging lens 204.

A light beam A in FIG. 18 is a light beam that is emitted from the light source 202 and transmitted through the front window 105. In a case where the raindrop 203 is not attached on the outer surface of the front window 105, the light that is emitted from the light source 202 and travels toward the front window 105 is transmitted through the front window 105 and directly leaks outside of the driver's car 100. Therefore, as the light source 202, in consideration of the light that strikes human eyes, it is preferable to select a light source of a wavelength and an amount of light in an eye-safe range. In addition, as illustrated in FIG. 18, it is more preferable to be structured such that light that is emitted from the light source 202 and travels toward the front window 105 travels upward in the vertical direction, and thereby a possibility of light striking the human eyes is reduced.

A light beam B in FIG. 18 is a light beam that is emitted from the light source 202, specularly-reflected by the inner surface of the front window 105, and incident to the imaging device 200. A part of the light that is emitted from the light source 202 and travels toward the front window 105 is specularly-reflected by the inner surface of the front window 105. Regarding a polarization component of this specularly-reflected light (light beam B), it is generally known that an S polarization component (horizontal polarization component S) that oscillates in a direction perpendicular to an incidence plane (vertical direction to a surface of a sheet of FIG. 18) is dominant. The specularly-reflected light (light beam B) that is emitted from the light source 202 and specularly-reflected by the inner surface of the front window 105 is not changed depending on an existence of the raindrop 203 attached on the outer surface of the front window 105, which is not only light unnecessary for the raindrop detection, but also ambient light that lowers the accuracy in the raindrop detection. In the present embodiment, the light beam B (horizontal polarization component S) is cut by the polarization filter layer 225 of the filter part of the raindrop detection 220B; therefore, it is possible to suppress lowering of the accuracy in the raindrop detection due to the light beam B.

A light beam C in FIG. 18 is a light beam that is emitted from the light source 202, transmitted through the inner surface of the front window 105, reflected by raindrops attached on the outer surface of the front window 105, and incident to the imaging device 200. A part of the light that is emitted from the light source 202 and travels toward the front window 105 is transmitted through the inner surface of the front window 105; however, the transmitted light has more vertical polarization components P than horizontal polarization components S. And in a case where the raindrop 203 is attached on the outer surface of the front window 105, the light transmitted through the inner surface of the front window 105 does not leak outside as the light beam A does, is multiply reflected inside the raindrop, is transmitted inside the front window 105 again and travels toward a side of the imaging device, and is incident to the imaging device 200. At this time, the infrared light transmission filter region 212 of the front filter 210 in the optical filter 205 of the imaging device 200 is structured so as to transmit an emission wavelength (infrared light) of the light source 202; therefore, the light beam C is transmitted through the infrared light transmission filter region 212. In addition, the polarization filter layer 225 of the filter part for the raindrop detection 220B of the consecutive rear filter 220 has the wire grid structure, and the longitudinal direction of the metal wire of the wire grid structure is formed so as to transmit the vertical polarization component P; therefore, the light beam C is transmitted through the polarization filter layer 225. Accordingly, the light beam C reaches the image sensor 206, and the raindrop detection is performed by a received-light amount by the image sensor 206.

A light beam D in FIG. 18 is a light beam that is transmitted through the front window 105 from outside the front window 105, and incident onto the filter part for the raindrop detection 220B of the imaging device 200. The light beam D also can be ambient light at the time of the raindrop detection; however, in the present embodiment, most of the light beam D is cut by the infrared light transmission filter region 212 of the front filter 210 in the optical filter 205. Accordingly, it is possible to suppress lowering of the accuracy in the raindrop detection due to the light beam D.

A light beam E in FIG. 18 is a light beam that is transmitted through the front window 105 from outside the front window 105, and incident onto the filter part for the car detection 220A of the imaging device 220. An infrared light range of the light beam E is cut by the infrared light cut filter region 211 of the front filter 210 in the optical filter 205, and only light in a visible range is imaged. The image thus imaged is used for the detection for the headlight of the oncoming car, the taillight of the car in front, the white line, or the like.

Note that in the present embodiment, a case where there is one light source 202 has been explained; however, a plurality of light sources 202 can be arranged. In that case, as the polarization filter layer 225 of the filter part for the raindrop detection 220B, one in which a plurality of polarization filter regions, the directions of transmission axes of which are different to each other are regionally divided so as to be repeated in a two-dimensionally arrangement direction of an imaging pixel by imaging pixel unit is used. And with respect to each polarization filter region, a transmission axis is set so as to transmit only a polarization component, a polarization direction of which is parallel to a virtual plane including an optical axis of light from a light source having a largest incident light amount to the polarization filter region of the plurality of the light sources 202 and an optical axis of the imaging lens 204.

Additionally, regardless of the number of the light sources 202, a direction of a transmission axis of the polarization filter layer 225 that is capable of appropriately removing ambient light specularly-reflected by the inner surface of the front window 105 is changed depending on a reflection point on the inner surface of the front window of ambient light incident onto each point of the polarization filter layer 225. This is because a front window 105 of a car is not only forwardly inclined downward, but also largely curved backward from a center part to both end parts in the right-and-left direction, in order to improve an aerodynamic characteristic. In such a case, in the image region for the raindrop detection 214 of an imaged image, ambient light is appropriately cut in the center part of the imaged image, but a case where ambient light is not appropriately cut in the both end parts can occur.

FIG. 19 is an explanatory diagram illustrating an example where the longitudinal direction of the metal wire of the wire grid structure is different at each position (points 1 to 3) of the polarization filter layer 225.

By having such a structure, it is possible to appropriately cut ambient light in the image region for the raindrop detection 214 of the imaged image entirely.

Note that as for the optical filter 205 in the present embodiment, the rear filter 220 having the polarization filter layer 222 and the spectral filter layer 223 that are regionally divided as illustrated in FIG. 14 is provided closer to a side of the image sensor 206 than the front filter 210; however, the front filter 210 can be provided closer to the side of the image sensor 206 than the rear filter 220.

Next, a flow of a detection operation of a car in front and an oncoming car in the present embodiment will be explained.

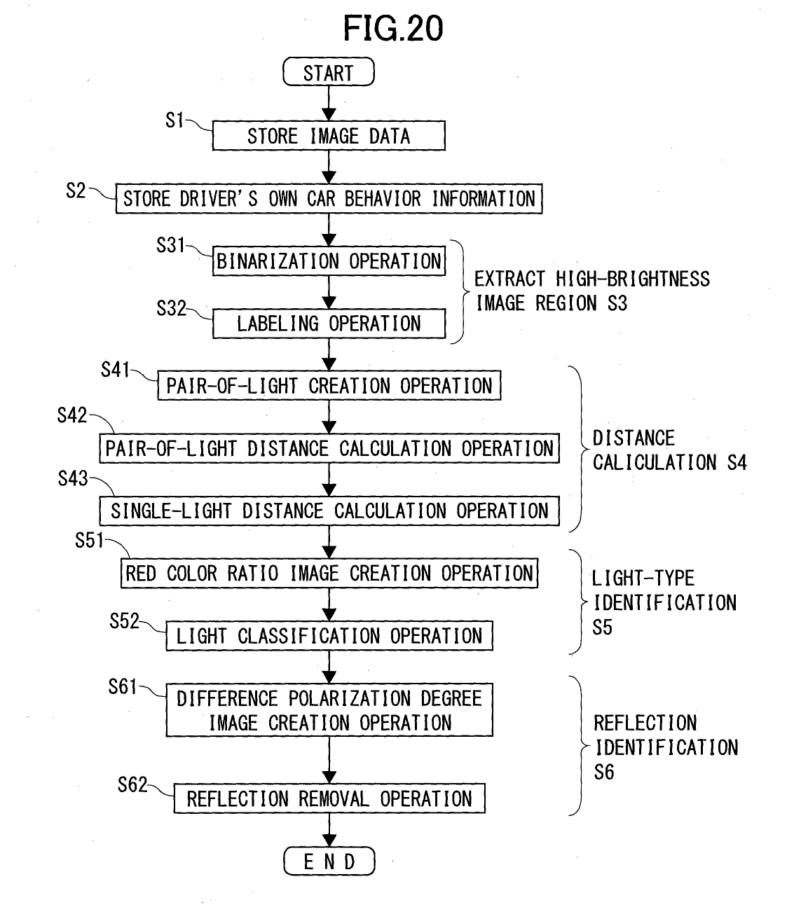

FIG. 20 is a flow diagram illustrating a flow of a car detection operation in the present embodiment.

In the car detection operation of the present embodiment, image processing is performed on image data imaged by the imaging device 200, and an image region considered to be an object to be detected is extracted. And, by identifying whether a type of a light source object shown in the image region is either of two types of objects to be detected, the detection of the car in front and the oncoming car is performed.

Firstly, in step S1, image data in front of the driver's car 100 imaged by the image sensor 206 of the imaging device 200 is stored in a memory. The image data includes a signal that shows brightness in each imaging pixel of the image sensor 206, as described above. Next, in step S2, information regarding a behavior of the driver's car 100 is obtained from a car behavior sensor (not illustrated).

In step S3, a high-brightness image region considered to be the objects to be detected (a taillight of the car in front and a headlight of the oncoming car) is extracted from the image data stored in the memory. The high-brightness image region is a bright region having higher brightness than a predetermined threshold brightness in the image data, and there usually is a case where there are a plurality of high-brightness regions, and all of those are extracted. Therefore, in this step, an image region showing reflected light from a wet road surface is also extracted as a high-brightness region.

In a high-brightness image region extraction operation, firstly, in step S31, a binarization operation is performed by comparing a brightness value of each imaging pixel on the image sensor 206 and the predetermined threshold brightness. Specifically, “1” is allocated to a pixel having brightness equal to or higher than the predetermined threshold brightness, and “0” is allocated to a pixel other than the above, and a binarized image is created. Next, in step S32, in the binarized image, in a case where pixels to which “1” is allocated are adjacent, a labeling operation that identifies those pixels as one high-brightness image region is performed. Thus, a collection of a plurality of adjacent pixels having a high-brightness value is extracted as one high-brightness image region.

In step S4 that is performed after the above high-brightness image region extraction operation, a distance between an object in the imaged region corresponding to each extracted high-brightness image region and the driver's car 100 is calculated. In this distance calculation operation (step S4), a pair-of-light distance calculation operation (step S42) that detects a distance by using light of a car that is a left-and-right pair of lights, and a single-light distance calculation operation (step S43) where in the case of a long distance, each one of the left-and-right pair of lights is not distinctively identified and the left-and-right pair of lights is identified as a single light are performed.

Firstly, for the pair-of-light distance calculation operation, in step S41, a pair-of-light creation operation that creates a pair of lights is performed. In the image data imaged by the imaging device 200, the left-and-right pair of lights satisfies a condition where each one of the left-and-right pair of lights is adjacent, and at a position of an approximately same height, each area of the high-brightness image region is approximately the same, and each shape of the high-brightness image region is the same. Therefore, two of high-brightness image regions that satisfy such a condition are taken as a pair of lights. A high-brightness image region that is not taken as the pair of lights is a single light. In a case where a pair of lights is created, by the pair-of-light distance calculation operation in step S42, a distance to the pair of lights is calculated. A distance between left and right headlights and a distance between left and right taillights of a car are approximated by a constant value “w0” (for example, about 1.5 m). On the other hand, since a focal length “f” in the imaging device 200 is known, by calculating a distance between left and right lights “w1” on the image sensor 206 of the imaging device 200, an actual distance “x” to the pair of lights is calculated by a simple proportion calculation (x=f·w0/w1). Note that for a distance detection to the car in front and the oncoming car, a special distance sensor such as a laser radar, a millimeter-wave radar, or the like can be used.

In step S5, a ratio (red color brightness ratio) of a red color image of the vertical polarization component P to a white color image of the vertical polarization component P is used as spectral information, and from the spectral information, a light-type identification operation that identifies the two of high-brightness image regions taken as the pair of lights by light from a headlight, or light from a taillight is performed. In the light-type identification operation, firstly in step S51, with respect to the high-brightness image region taken as the pair of lights, a red color ratio image in which a ratio of pixel data corresponding to the imaging pixels “a, f” on the image sensor 206 to pixel data corresponding to the imaging pixel “b” on the image sensor 206 is taken as a pixel value is created (red color ratio image creation operation). And then, in step S52, a light classification operation where the pixel value of the red color ratio image is compared to a predetermined threshold value, a high-brightness image region in which the pixel value is equal to or more than the predetermined threshold value is taken as a taillight image region by the light from the taillight, and a high-brightness image region in which the pixel value is less than the predetermined threshold value is taken as a headlight image region by the light from the headlight is performed.

And then, in step S6, with respect to each image region identified as the taillight image region and the headlight image region, by using a difference polarization degree ((S−P)/(S+P)) as polarization information, a reflection identification operation that identifies direct light from the taillight or the headlight, or reflected light reflected by a mirror surface part of the wet road surface and received or the like is performed. In the reflection identification operation, firstly in step S61, with respect to the taillight image region, the difference polarization degree ((S−P)/(S+P)) is calculated, and a difference polarization degree image where the calculated difference polarization degree is taken as a pixel value is created. And likewise, with respect to the headlight image region, the difference polarization degree ((S−P)/(S+P)) is calculated, and a difference polarization degree image where the calculated difference polarization degree is taken as a pixel value is created (difference polarization degree image creation operation). And in step S62, a reflection removal operation where a pixel value of each difference polarization degree image is compared to a predetermined threshold value, a taillight image region and a headlight image region in which the pixel value is equal to or more than the predetermined value is determined to be an image region by the reflected light, each image region by the reflected light is taken as a image region which does not show the taillight of the car in front, or the headlight of the oncoming car, and is removed is performed. The taillight image region and the headlight image region that remain after the above removal operation are identified as an image region that shows the taillight of the car in front, or an image region that shows the headlight of the oncoming car.

Note that only in a case where a car is equipped with a rain sensor, and the rain sensor determines that it is raining, can the above reflection identification operation S6 be performed. Additionally, only in a case where a windshield wiper is operated by a driver, can the above reflection identification operation S6 be performed. In short, the above reflection identification operation S6 can be performed only at the time of raining when reflection by a wet road surface is assumed.

A detection result of the car in the front and the oncoming car detected by the above-described car detection operation is used for a light distribution control of a headlight as an in-car device of the driver's car 100 in the present embodiment. In particular, in a case of detecting a taillight of a car in front by the car detection operation, and moving closer to a range of a distance where illumination light of the headlight of the driver's car 100 is incident to a rearview mirror of the car in front, the control that blocks a part of the headlight of the driver's car 100, and shifts a direction of the illumination light of the headlight of the driver's car 100 in an up-and-down direction or a right-and-left direction is performed such that the illumination light of the headlight of the driver's car 100 does not strike the car in front. In addition, in a case of detecting a headlight of an oncoming car by the car detection operation, and moving closer to a range of a distance where illumination light of the headlight of the driver's car 100 strikes a driver of the oncoming car, the control that blocks a part of the headlight of the driver's car 100, and shifts a direction of the illumination light of the headlight of the driver's car 100 in an up-and-down direction or a right-and-left direction is performed such that the illumination light of the headlight of the driver's car 100 does not strike the oncoming car.

### [White Line Detection Operation]

Hereinafter, a white line detection operation in the present embodiment will be explained.

In the present embodiment, for the purpose of preventing the driver's car 100 from deviating from a travelling region, the operation that detects a white line (road marking line) as an object to be detected is performed. The term “white line” here includes all types of road marking white lines such as solid lines, dashed lines, dotted lines, double lines, and the like. Note that likewise, road marking lines of colors other than white such as yellow and the like are also detectable.

In the white line detection operation of the present embodiment, polarization information of the vertical polarization component P of a white color component (non-spectral light) among information obtainable from the imaging unit 101 is used. Note that the vertical polarization component P of the white color component can include a vertical polarization component of cyan light. It is generally known that the white line and an asphalt surface have a flat spectral brightness characteristic in a visible light region. On the other hand, cyan light includes a wide range in the visible light region; therefore, it is suitable for imaging the asphalt surface and the white line. Accordingly, by using the optical filter 205, and including the vertical polarization component of the cyan light in the vertical polarization component of the white color component, the number of used imaging pixels increases, and as a result, resolution increases, and it is also possible to detect a white line in the distance.

In the white line detection operation of the present embodiment, on many roads, a white line is formed on a surface of a road, a color of which is close to black, and in an image of the vertical polarization component P of the white color component (non-spectral light), brightness of a part of the white line is sufficiently larger than that of another part on the surface of the road. Therefore, brightness on the surface of the road that is equal to or more than a predetermined value is determined to be the white line, and thus, it is possible to detect the white line. In particular, in the present embodiment, since the horizontal polarization component S is cut in a used image of the vertical polarization component P of the white color component (non-spectral light), it is possible to obtain an image in which reflected light from the wet road surface, or the like is suppressed. Therefore, it is possible to perform the white line detection without a false detection where ambient light such as reflected light of the headlight from the wet road surface at night, or the like is detected as the white line.

Additionally, in the white line detection operation of the present embodiment, among the information obtainable from the imaging unit 101, polarization information by comparison of the horizontal polarization component S of the white color component (non-spectral light) with the vertical polarization component P of that, for example, a difference polarization degree ((S−P)/(S+P)) of the horizontal polarization component S of the white color component (non-spectral light) and the vertical polarization component P of that can be used. As for reflected light from the white line, generally, a diffuse reflection component is dominant. Therefore, the vertical polarization component P and the horizontal polarization component S of the reflected light are approximately equal, and the difference polarization degree shows a value close to zero. On the other hand, on an asphalt surface part where the white line is not formed, when it is dry, a characteristic shows that the diffuse reflection component is dominant, and a difference polarization degree of which shows a positive value. Additionally, on the asphalt surface part where the white line is not formed, when it is wet, a specular reflection component is dominant, and a difference polarization degree of which shows a larger value. Therefore, it is possible to determine a part where an obtained difference polarization value on the road surface part is smaller than a predetermined threshold value to be the white line.

### [Raindrop Detection Operation on Front Window]

Hereinafter, a raindrop detection operation of the present embodiment will be explained.

In the present embodiment, for the purpose of performing drive control of the windshield wiper 107 and squirt control of a windshield washer fluid, an operation that detects a raindrop as an object to be detected is performed. Note that here, a case where a raindrop is the attached matter is taken as an example, and will be explained, and this applies to cases of attached matter such as bird droppings, and water splash from nearby cars as well.

In the raindrop detection operation of the present embodiment, among the information obtainable from the imaging unit 101, polarization information of the vertical polarization component P of the image region for the raindrop detection 214 that receives light transmitted through the infrared light transmission filter layer 212 of the front filter 210, and the polarization filter layer 225 in the filter part for the raindrop detection 220B of the rear filter 220 is used.

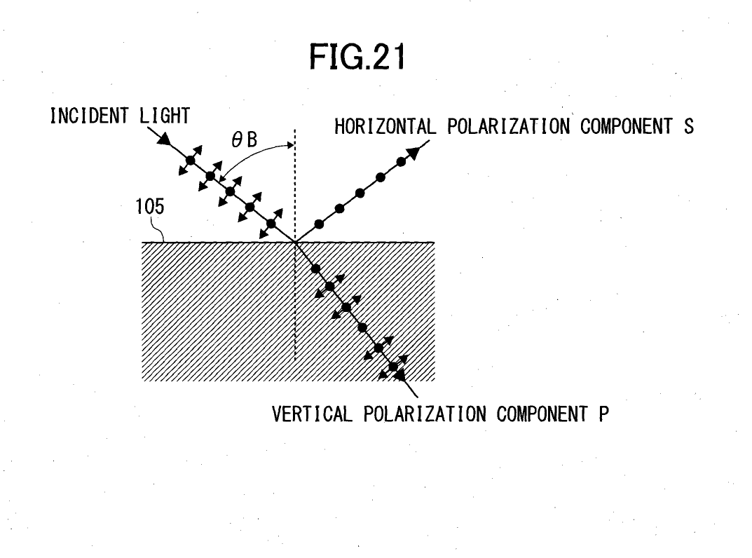

FIG. 21 is an explanatory diagram illustrating a polarization state of reflected light at a Brewster's angle.

Generally, when light is incident on a flat surface such as a glass, or the like, reflectance of the horizontal polarization component S monotonously increases with respect to an incident angle; however, reflectance of the vertical polarization component P becomes zero at a specific angle (Brewster's angle GB), and the vertical polarization component P is not reflected as illustrated in FIG. 21, and is only transmitted light. Therefore, the light source 202 is structured such that only light of the vertical polarization component P is emitted toward the front window 105 from the interior of the car with the incident angle of the Brewster's angle GB, so that reflected light by the inner surface (surface on a side of the interior of the car) of the front window 105 does not occur, and light of the vertical polarization component P is emitted to the outer surface (surface on a side of an exterior of the car) of the front window 105. When reflected light by the inner surface of the front window 105 exists, the reflected light becomes ambient light to the imaging device 200, and becomes a factor for reduction of a raindrop detection rate.

In order that only the vertical polarization component P of light emitted from the light source 202 can be incident to the front window 105, in a case where, for example, a light-emitting diode (LED) is used as the light source 202, between the light source 202 and the front window 105, it is preferable that a polarizer that transmits only the vertical polarization component P be arranged. Additionally, in a case where a laser diode (LD) is used as the light source 202, since the LD emits only light of a specific polarization component, an axis of the LD can be adjusted such that only light of the vertical polarization component P is incident to the front window 105.

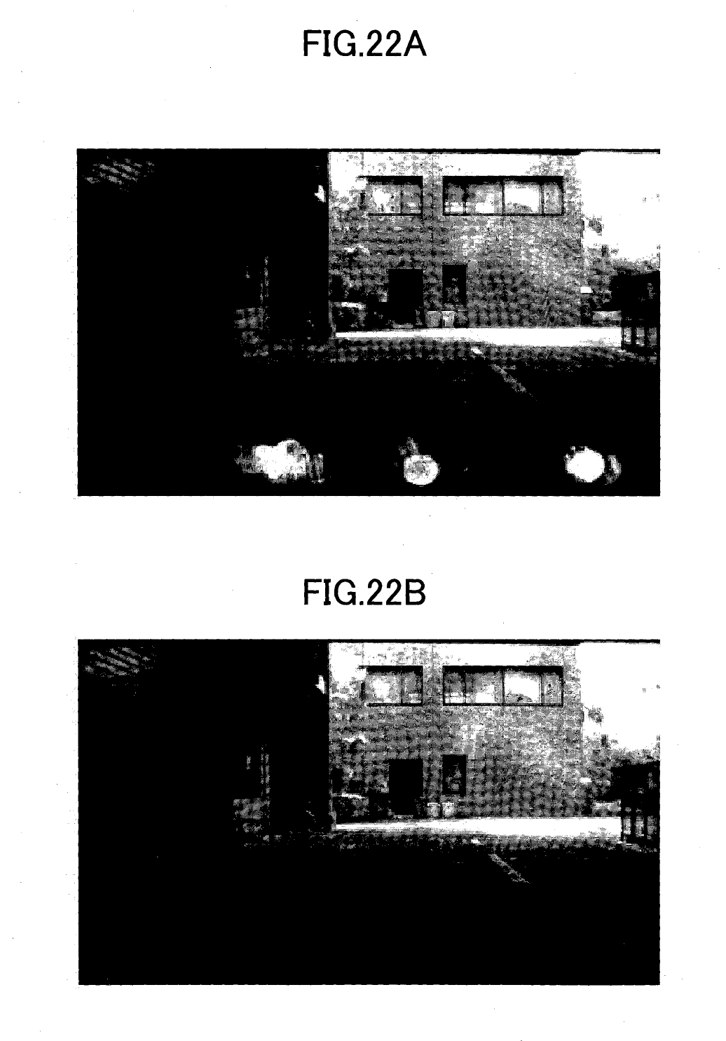

FIG. 22A is an explanatory diagram illustrating an imaged image when raindrops are attached on the outer surface of the front window 105.

FIG. 22B is an explanatory diagram illustrating an imaged image when raindrops are not attached on the outer surface of the front window 105.

In each of the imaged image of FIGS. 22A and 22B, a lower region in the drawing is the image region for the raindrop detection 214, and the rest in the drawing is the image region for the car detection 213. In the image region for the raindrop detection 214, when raindrops are attached, as illustrated in FIG. 22A, light from the light source 202 is shown, and when raindrops are not attached, as illustrated in FIG. 22B, light from the light source 202 is not shown. Therefore, it is possible to easily perform an identification operation of a raindrop image in the image region for the raindrop detection 214 by adjusting a threshold value of a received-light amount from the light source 202. Note that the threshold value is not needed to be a fixed value, and can be appropriately changed depending on a change of circumstances or the like around a driver's car equipped with the imaging device 200. For example, an optimal value is calculated based on exposure adjustment information or the like of the imaging device 200, and the threshold value can be changed.

In the present embodiment, by the infrared light transmission filter region 212 of the front filter 210 in the optical filter 205, light other than infrared light such as visible light that transmits through the front window 105 from outside of the front window 105 and is incident to the filter part for the raindrop detection 220B of the imaging device 200 or the like is cut. Thus, ambient light that is incident from outside of the front window 105 is reduced, and reduction of the accuracy in the raindrop detection due to such ambient light is suppressed.

Furthermore, in the present embodiment, light transmitted through the polarization filter layer 225 of the filter part for the raindrop detection 220B is only the vertical polarization component P, and the horizontal polarization component S that occupies a large amount of the ambient light of the reflection of the inner surface of the front window 105, the specularly-reflected light that is emitted from the light source 202 and specularly-reflected by the inner surface of the front window 105, or the like are also cut. Thus, reduction of the accuracy in the raindrop detection due to such ambient light is also suppressed.

However, even though the ambient light is thus cut by the infrared light transmission filter region 212 and the polarization filter layer 225 of the optical filter 205, there is a case where the accuracy in the raindrop detection is reduced by ambient light such as infrared light that is incident from outside of the front window 105, or the like. Therefore, in the present embodiment, in order to identify ambient light that is not able to be cut by the optical filter 205 from reflected light from raindrops, the following image processing is performed.

Before explaining a specific rain detection operation, in the present embodiment, a mechanism that identifies the ambient light that is not able to be cut by the optical filter 205 from the reflected light from the raindrops will be explained.

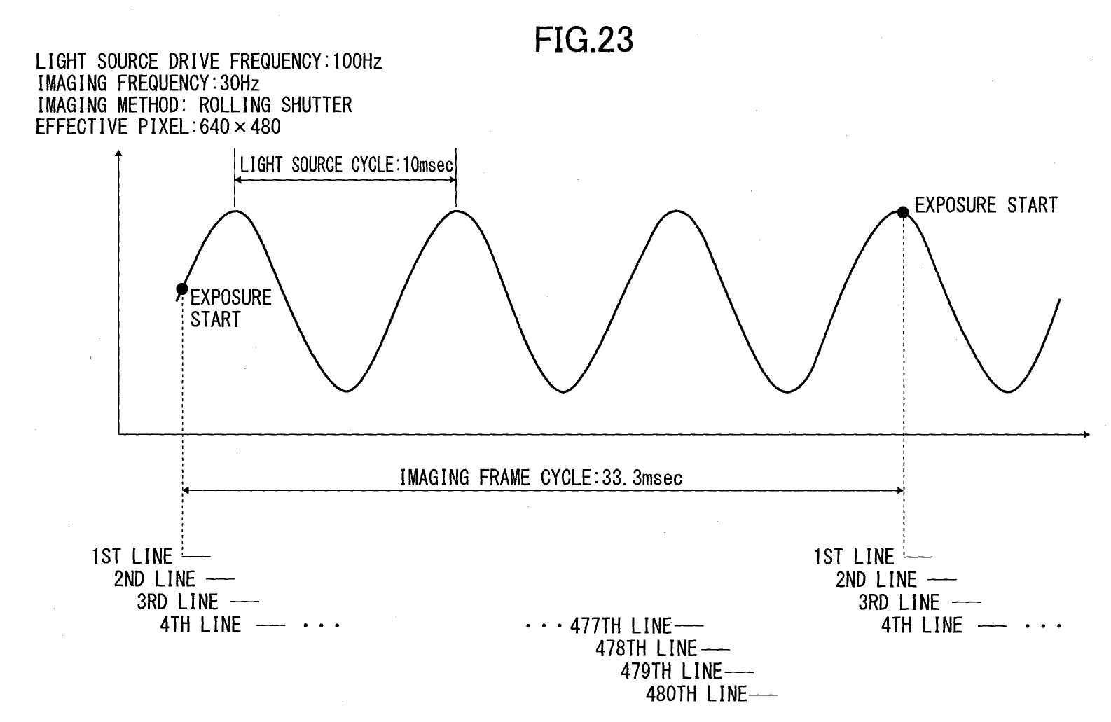

FIG. 23 is an explanatory diagram illustrating a relationship between a drive frequency (light source cycle) of the light source 202 and an imaging frequency (imaging frame cycle) when the imaging device 200 consecutively images imaged images.

The light source 202 in the present embodiment drives at a predetermined drive frequency (in the present embodiment, 100 Hz is taken as an example.), and emits light that flickers in accordance with the drive frequency. On the other hand, the imaging device 200 in the present embodiment consecutively images imaged images at a predetermined imaging frequency (in the present embodiment, 30 Hz is taken as an example.), and is capable of obtaining each single imaged image per imaging frame cycle (33.3 ms) corresponding to the imaging frequency.

In the present embodiment, with respect to the relationship between the drive frequency of the light source 202 (hereinafter, referred to as “light source drive frequency”) and the imaging frequency of the imaging device 200, one of the light source drive frequency and the imaging frequency is set to deviate from an integral multiple of the other. Therefore, as illustrated in FIG. 23, intensity of light emitted from the light source 202 at the time of starting previous imaging, and at the time of starting latest imaging are different. As a result, even if reflected light of light emitted from the light source 202 is light reflected by the same point (raindrop), the reflected light is received by an image sensor of the light source 202 at a different received-light amount between a previous imaged image and a latest imaged image. On the other hand, ambient light that is not the light emitted from the light source 202 normally is not light that flickers in a short cycle as the light emitted from the light source 202. Therefore, with respect to such ambient light, there is no difference in received-light amounts received by the image sensor of the imaging device 200 between the previous imaged image and the latest imaged image.

Therefore, by such difference between the reflected light from the raindrop and the ambient light, those are identified. Specifically, if there is a difference in the received-light amounts between the previous imaged image and the latest imaged image, an image region of which is a region that shows a raindrop, and even if an image region where there is no difference in the received-light amounts between the previous imaged image and the latest imaged image is a region where a certain amount of light is received, it is possible to determine a region that shows the raindrop.

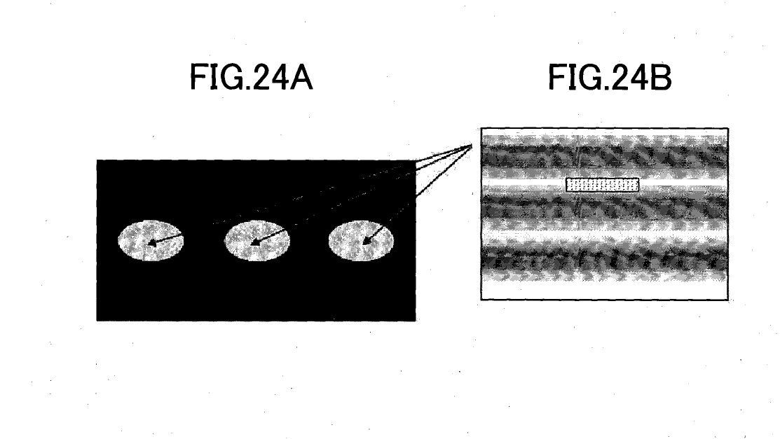

Here, the imaging device 200 in the present embodiment adopts a rolling shutter method, and obtains image data at a predetermined signal acquisition frequency in a unit of an image line that extends in the horizontal direction on the image sensor. Therefore, in a single imaged image, in the imaged region where the raindrop is shown illustrated in FIG. 24A (region that receives reflected-light that is emitted from the light source 202, and reflected by a raindrop), as illustrated in FIG. 24B, in an arrangement direction (vertical direction) of the image line, stripe patterns of different tones that show intensity of the received-light amounts appear in a cycle of a beat occurring by the difference between the signal acquisition frequency and the light source drive frequency. At this time, in a case where with respect to a detection unit region that determines the difference of the received-light amounts between the previous imaged image and the latest imaged image, a length (the number of image lines) in a vertical row direction (vertical direction) of the imaging pixel of the image sensor is set corresponding to the number of the image lines corresponding to the cycle of the above stripe patterns, a total amount, or an average amount of the received-light amount in the detection unit region becomes the same between the previous imaged image and the latest imaged image. In this case, an operation for detecting the difference of the received-light amounts between the previous imaged image and the latest imaged image becomes complex. Therefore, as illustrated in FIG. 24B, it is preferable that the detection unit region be set such that the length in the vertical row direction of the imaging pixel in the detection unit region (the number of the image lines) becomes smaller than a value of the number of the image lines converted from the cycle of the stripe patterns.

Note that in a case of adopting the rolling shutter method, as described above, in the single imaged image, the stripe patterns of the different tones that show the intensity of the received-light amount appear in the cycle of the beat occurring by the difference between the signal acquisition frequency and the light source drive frequency. Therefore, if the beat is detected, even if only a single imaged image, it is possible to determine the region that shows the raindrop.

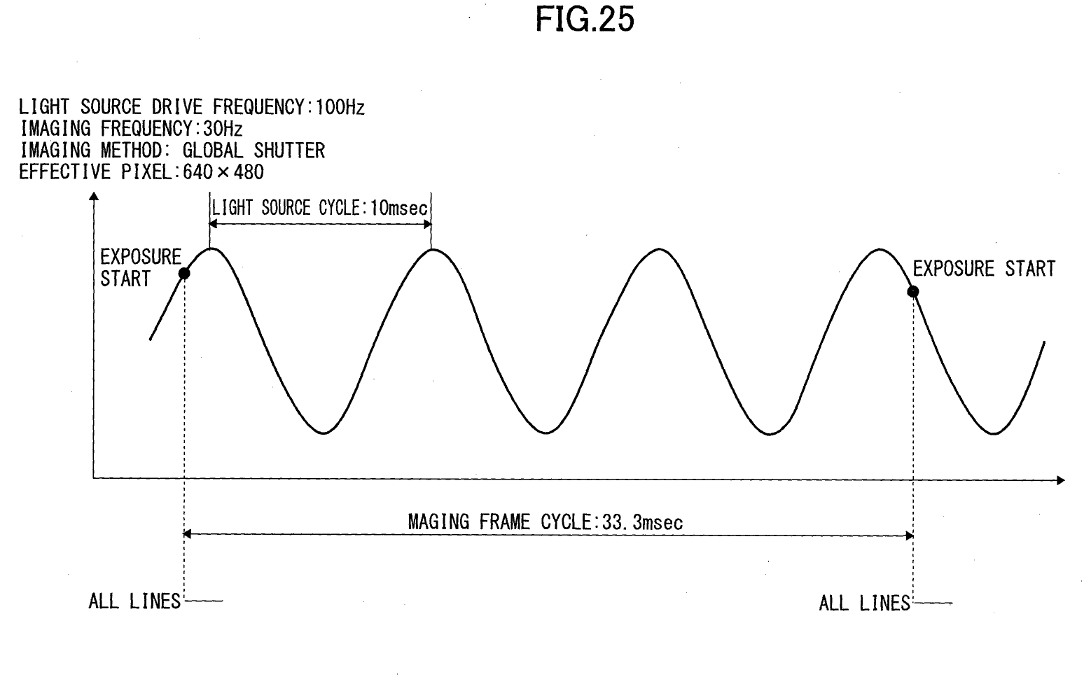

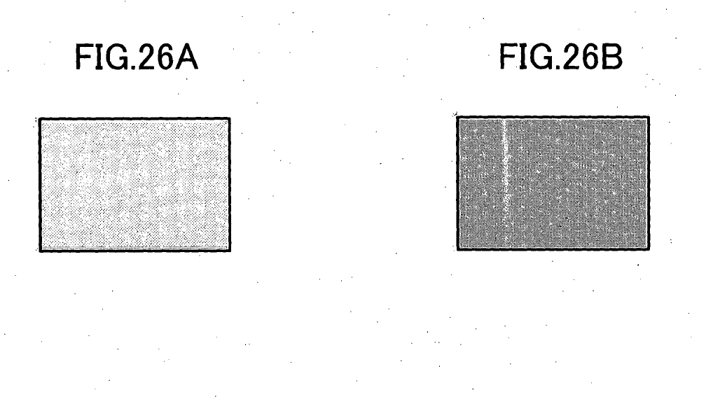

Note that as the imaging device 200 in the present embodiment, not only the rolling shutter method, but also a global shutter method as illustrated in FIG. 25 can be adopted. In this case, the stripe patterns of the different tones do not appear in the single imaged image as in the rolling shutter method. However, if the relationship between the light source drive frequency and the imaging frequency is set to deviate from the integral multiple of each other's, as illustrated in FIGS. 26A and 26B, in the image region that shows the raindrop (region that receives light that is emitted from the light source 202 and reflected by the raindrop), a difference of the received-light amounts appear between the previous imaged image and the latest imaged image.

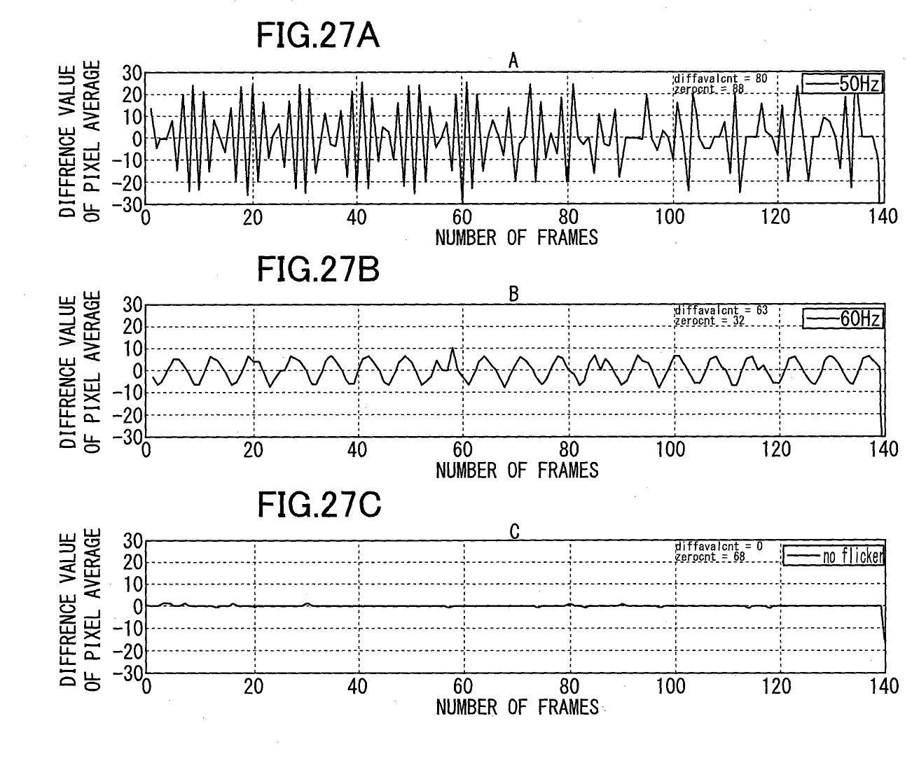

FIG. 27A is a graph illustrating a change of an average value of a pixel value in an image region that shows a raindrop in an imaged image consecutively shot, in a case where a light source drive frequency is 50 Hz.

FIG. 27B is a graph illustrating a change of an average value of a pixel value in an image region that shows a raindrop in an imaged image consecutively shot, in a case where the light source drive frequency is 60 Hz.

FIG. 27C is a graph illustrating a change of an average value of a pixel value in an image region that shows a raindrop in an imaged image consecutively shot, in a case where the light source drive frequency is 0 Hz (that is, in a case of emitting light with no flicker).

As illustrated in FIG. 27A, in a case where the light source drive frequency is 50 Hz, a difference between the above and the imaging frequency (30 Hz) is relatively small; therefore, a change cycle of the average value of the pixel value is short. On the other hand, as illustrated in FIG. 27B, in a case where the light source drive frequency is 60 Hz, a difference between the above and the imaging frequency (30 Hz) is relatively large; therefore, the change cycle of the average value of the pixel value is long. As comparison data, as illustrated in FIG. 27C, in a case where the light source drive frequency is 0 Hz, that is, in a case of emitting light with no flicker, the beat does not occur in the image, and no change appears in the average value of the pixel value.

Here, contents of the rain detection operation in the present embodiment will be specifically explained.

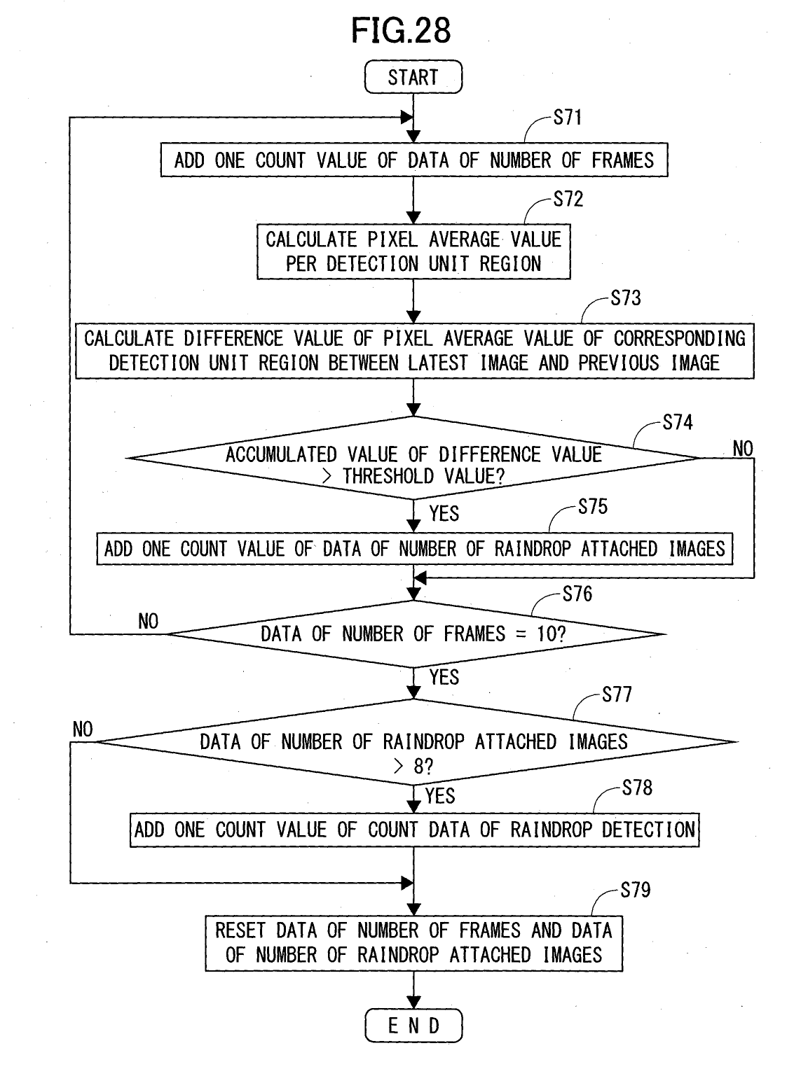

FIG. 28 is a flow diagram illustrating a flow of the raindrop detection operation in the present embodiment.

When imaged image data is inputted from the imaging device 200 of the imaging unit 101, after adding one count value of data of the number of the frames (step S71), the image analysis unit 102 functions as an attached matter detection processor, and calculates an average value of the pixel value (hereinafter, referred to as “pixel average value”) in the detection unit region per unit image region (detection unit region) obtained by dividing the image region for the raindrop detection 214 into a plurality of regions (step S72).

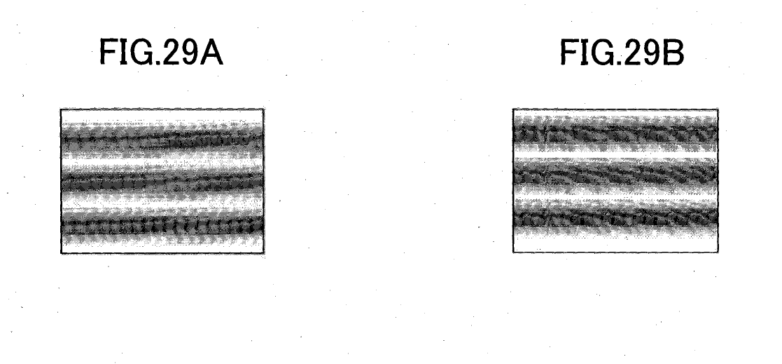

In the image analysis unit 102, image data of the image region for the raindrop detection 214 consecutively imaged at a predetermined imaging frequency (30 Hz) is sequentially inputted. The image analysis unit 102 at least stores image data of a latest imaged image (image of the image region for raindrop detection 214), and image data of a previously-imaged image or an earlier-than-previously imaged image in a predetermined image memory. In the present embodiment, latest imaged image data as illustrated in FIG. 29B, and previously-imaged image data as illustrated in FIG. 29A are stored in an image memory, and a comparison operation is performed between those imaged image data.

Specifically, with respect to the pixel average value calculated in step S72, per detection unit region, a difference value between the latest imaged image data and the previously-imaged image data is calculated (step S73). And it is determined whether an accumulated value of each difference value calculated per detection unit region exceeds a predetermined threshold value or not (step S74), and if it is determined that the accumulated value exceeds the predetermined threshold value, one count value of data of the number of raindrop attached images is added (step S75). If it is determined that the accumulated value does not exceed the predetermined threshold value, no count value of the data of the number of the raindrop attached images is added.

With respect to 10 imaged image data, operations of the above steps S71 to 75 are repeatedly performed, and if the count value of the data of the number of the frames reaches 10 (Yes of step S76), then it is determined whether the count value of the data of the number of the raindrop attached images exceeds a predetermined raindrop detection threshold value (in the present embodiment, “8” is taken as an example.) (step S77). As a result, in a case where it is determined that the count value of the data of the number of the raindrop attached images exceeds the predetermined raindrop detection threshold value, one count value of raindrop detection count data is added (step S78). And then, the count values of the data of the number of the frames and the data of the number of the raindrop attached images are reset to zero (step S79), and the operation proceeds to a next raindrop detection operation.

Thus, in the present embodiment, the raindrop detection operation is repeatedly performed in a unit of 10 consecutively imaged images, and a detection result of existence of raindrops in each raindrop detection operation is counted in the raindrop detection count data. The windshield wiper control unit 106 performs the drive control of the windshield wiper 107 or the squirt control of the windshield washer fluid, for example, when the raindrop detection count data satisfies a predetermined condition (such as a case of consecutively counting 10 images).

Note that in a case where one is added to the count value of the raindrop detection count data in a state of zero, control that increases the imaging frequency of the imaging device 200 can be performed. Therefore, until a first raindrop is detected, the imaging device 200 images in a relatively low imaging frequency, and it is possible to continuously perform the operation in a light operation load. On the other hand, it can be said that a time when the first raindrop is detected is likely to be a time when the rain starts to fall, and later it is highly possible to be a state where raindrops are attached. Therefore, in a state where it is highly possible that raindrops are attached, by increasing the imaging frequency after detecting the first raindrop, it is possible to repeat more raindrop detection operations in a shorter time, and to realize the existence of the raindrops more promptly.

Additionally, in a case where image data from the image sensor when a raindrop image region is shown in the image region for the raindrop detection shows a saturation value, it is preferable to adjust so as to reduce the intensity of light emission of the light source 202. Thus, without reducing the accuracy in the detection of the reflected light from the raindrop, it is possible to reduce a noise component, and improve the accuracy in the raindrop detection.

In order to confirm an effect of the raindrop detection operation in the present embodiment, an effect confirmation test that compares the present embodiment and a comparison example that simply detects an image region in which a received-light amount that exceeds a predetermined threshold value is detected in the image region for the raindrop detection 214 as the raindrop image region will be explained.

In the effect confirmation test, with respect to each of a state where raindrops are attached on the front window and a state where raindrops are not attached on the front window, the raindrop detection operation is performed while actually driving on the road. In the effect confirmation test, 1000 imaged images are consecutively imaged, 10 imaged images are taken as one detection unit, and detections of the existence of the raindrop are performed 100 times at a maximum. Note that in the comparison example, it is confirmed that a raindrop is attached when it is detected that a received-light amount exceeds a threshold value with respect to 8 imaged images of 10 imaged images.

A result of an effect confirmation test that is performed in the daytime where there is no ambient light from a headlight of an oncoming car is as follows.

In both of the present embodiment and the comparison example, in a state where raindrops are attached on the front window, it is detected that the raindrops are attached 100 times out of 100. On the other hand, comparing to a state where raindrops are not attached on the front window, in the comparison example, a false detection is performed 5 times out of 100, and in the present embodiment, a false detection is performed only 1 time out of 100.

Additionally, a result of an effect confirmation test that is performed at night where there is ambient light from a headlight of an oncoming car is as follows.

In both of the present embodiment and the comparison example, in a state where raindrops are attached on the front window, it is detected that the raindrops are attached 100 times out of 100. On the other hand, comparing to a state where raindrops are not attached on the front window, in the comparison example, a false detection is performed 8 times out of 100, and in the present embodiment, a false detection is performed only 2 times out of 100.

Thus, in the present embodiment, even in the daytime, and even at night where the ambient light from the headlight of the oncoming car is incident, and thereby the accuracy in the raindrop detection is likely to be lower than in the daytime, it is possible to obtain higher accuracy in the raindrop detection with respect to the comparison example.

According to an embodiment of the present invention, the following effects are obtained.

According to an embodiment of the present invention, due to a difference between a drive frequency of a light source and an imaging frequency of an imaging device, with respect to an image region of reflected light that is emitted from the light source and reflected by attached matter, a beat is generated on an imaged image. On the other hand, ambient light that is not light emitted from the light source, generally, is not light that flickers in a short cycle as the light emitted from the light source, and does not generate a beat between the ambient light and the imaging frequency of the imaging device. Therefore, by using such a difference between the reflected light from the attached matter and the ambient light, it is possible to identify the reflected light from the attached matter from the ambient light with high accuracy.

According to an embodiment of the present invention, it is possible to generate a beat stably.

According to an embodiment of the present invention, it is possible to previously cut ambient light in a wavelength range that deviates from a wavelength range of the reflected light from the attached matter (a specific wavelength emitted by the light source) by an optical filter, and therefore, it is possible to identify the reflected light from the attached matter from the ambient light with higher accuracy.

According to an embodiment of the present invention, it is possible to previously cut the horizontal polarization component S that occupies a large amount of the ambient light of the reflection of the inner surface of the front window 105, the specularly-reflected light that is emitted from the light source 202 and specularly-reflected by the inner surface of the front window 105, or the like, and therefore, it is possible to identify the reflected light from the attached matter from the ambient light with higher accuracy.

According to an embodiment of the present invention, even in a case where the beat is not accurately detected by one image, by comparing a plurality of images, it is possible to accurately detect the beat.

According to an embodiment of the present invention, it is possible to accurately detect the beat by a simple calculation operation.

According to an embodiment of the present invention, in an imaging device that adopts a rolling shutter method, in a case of comparing a plurality of images imaged at different times, it is possible to greatly take a difference between the plurality of images.

According to an embodiment of the present invention, in a state where the attached matter is not detected, it is possible to reduce an operation load of the imaging device by imaging at a relatively low imaging frequency, and in a state after detecting the attached matter, it is possible to repeat more raindrop detection operations in a shorter time, and to realize the existence of raindrops more promptly.

According to an embodiment of the present invention, without lowering accuracy in detection of reflected light from a raindrop, it is possible to reduce a noise component, and improve accuracy in raindrop detection.

According to an embodiment of the present invention, by a difference of existence of a beat generation, it is possible to identify the reflected light from the attached matter from the ambient light with high accuracy.

According to an embodiment of the present invention, accuracy in identifying reflected light from attached matter such as a raindrop that is attached on a transparent member from ambient light is improved, and it is possible to obtain a beneficial effect on reduction in a frequency of a false detection that identifies the ambient light as the reflected light from the attached matter.

Although the present invention has been described in terms of exemplary embodiments, it is not limited thereto. It should be appreciated that variations may be made in the embodiments described by persons skilled in the art without departing from the scope of the present invention defined by the following claims.

### CROSS-REFERENCE TO RELATED APPLICATIONS

The present application is based on and claims priority from Japanese Patent Application Number 2011-262113, filed Nov. 30, 2011, the disclosure of which is hereby incorporated reference herein in its entirety.

1. An attached matter detector comprising:
a light source that emits light to a transparent member;
an imaging device that receives light that is emitted from the light source and reflected by attached matter attached on the transparent member by an image sensor, a light-receiving element of which is structured by a two-dimensionally-arranged imaging pixel array, and consecutively images an image of the attached matter attached on the transparent member at a predetermined imaging frequency; and
an attached matter detection processor that detects the attached matter based on an image imaged by the imaging device,
wherein the light source emits light that flickers at a drive frequency that is different from the imaging frequency, and the imaging device receives the reflected light by the image sensor via an optical filter that selects and transmits the reflected light, and the attached matter detection processor detects a beat on an image generated by a difference between the imaging frequency and the drive frequency, and identifies an image region where the beat is detected as an attached matter image region where the attached matter is shown.

2. The attached matter detector according to claim 1, wherein one of the drive frequency and the imaging frequency is set to deviate from an integral multiple of the other.

3. The attached matter detector according to claim 2, wherein the light source emits light of a specific wavelength range, and the optical filter includes an optical filter that selects and transmits the specific wavelength range.

4. The attached matter detector according to claim 3, wherein the optical filter includes an optical filter that selects and transmits a specific polarization component.

5. The attached matter detector according to claim 4, wherein the attached matter detection processor compares a plurality of images imaged at different times, and detects the beat.

6. The attached matter detector according to claim 5, wherein the attached matter detection processor detects the beat based on difference information between the plurality of images imaged at different times.

7. The attached matter detector according to claim 6, wherein the imaging device obtains image data in a unit of one image line, or equal to or more than two image lines on the image sensor at a predetermined signal acquisition frequency, and images an image of the attached matter, and the attached matter detection processor detects the beat by comparing a pixel value between the plurality of images per unit image region obtained by dividing an imaged image into a plurality of regions, and a value of the number of an image line converted from a size in an arrangement direction of the image line in the unit image region is set smaller than a value of the number of an image line from a cycle of a beat generated by a difference between the signal acquisition frequency and the drive frequency.

8. The attached matter detector according to claim 7, comprising:
an imaging frequency changer that performs control that increases an imaging frequency of the imaging device, when changing from a state where the attached matter is not detected by the attached matter detection processor to a state where the attached matter is detected.

9. The attached matter detector according to claim 8, comprising:
a light emission intensity adjuster that determines whether image data from the image sensor shows a saturation value, when the attached mater is detected by the attached matter detection processor, and adjusts light emission intensity of the light source based on the determination result.

10. An attached matter detection method, comprising the steps of:
emitting light to a transparent member from a light source;
receiving reflected light by attached matter attached on the transparent member by an image sensor, a light-receiving element of which is two-dimensionally structured by an imaging array, and consecutively images an image of the attached matter at a predetermined imaging frequency; and
detecting the attached matter based on an imaged image, wherein the light source that emits light that flickers at a drive frequency that is different from the imaging frequency is used, the reflected light is received by the image sensor via an optical filter that selects and transmits the reflected light, a beat on an image generated by a difference between the imaging frequency and the drive frequency is detected, and an image region where the beat is detected is identified as an attached matter image region where the attached matter is shown.
